(19) United States
(12) Patent Application Publication
(10) Pub. No.: US 2026/0194494 A1
(43) Pub. Date: Jul. 9, 2026

(54) METHOD FOR CHECKING AND/OR PUTTING INTO SERVICE A MODULAR MEASUREMENT SYSTEM

(71) Applicant: Endress+Hauser Flowtec AG, Reinach (CH)

(72) Inventor: Michael Kirst, Lörrach (DE)

(21) Appl. No.: 19/134,580

(22) PCT Filed: Nov. 16, 2023
(86) PCT No.: PCT/EP2023/081985

§ 371 Date: May 30, 2025

(30) Foreign Application Priority Data
Dec. 2, 2022 (DE) 10 2022 131 972.5
Jan. 26, 2023 (DE) 10 2023 101 930.9

(51) Int. Cl. G01N 29/30; G01N 29/02

(52) U.S. Cl. CPC G01N 29/30; G01N 29/02

(57) ABSTRACT

A measuring system includes a base module, including converter electronics, and a sensor module connected to the base module and coupled to the converter electronics for signal communication. The sensor module is configured to set or change a signal parameter of at least one electrical measurement signal at a signal input of the converter electronics according to at least one measured variable of the medium. The base module is calibrated on site using both the sensor module and at least one reference measurement value for a sensor module-specific calibration parameter determined under reference calibration conditions.

The invention relates to a method for checking and/or putting (back) into service a modular measuring system used to measure at least one measured variable of a fluid (measurement) medium and a modular measuring system suitable for performing such a method.

Documents DE-A 102008029956, DE-A 102021105397, DE-A 102019009024, DE-A 102020112154, DE-A 102020114519, DE-A 102020118702, DE-A 102020127356, DE-A 102020131452, DE-A 102020132223, DE-A 102020132685, DE-A 102020132686, DE-A 102020132986, DE-A 102020133566, DE-A 102020133614, DE-A 102020133851, WO-A 2019/017891, WO-A 2021121867 or WO-A 2022/242975 as well as the (not pre-published) international patent application PCT/EP2022/076349 disclose modular measuring systems, namely those formed by means of a base module (installed on site) having (programmable) converter electronics and a (n) (exchangeable) sensor module (removably) mechanically connected to the base module (already installed previously on site) and used to record at least one measured variable of a fluid (measuring) medium or measuring substance flowing in a (measuring substance) line, namely to determine measurement values for one or more measured variables, for example a mass flow, a volume flow, a density, a viscosity, a temperature, a pressure, a pH value, etc., of the (measuring) medium. The converter electronics of measuring systems of the type in question are typically formed by means of one or more microprocessors and/or one or more digital signal processors and are also regularly configured to be electrically connected to a superordinate electronic data processing system (EDP), for example formed by means of a programmable logic controller (PLC) and/or a process control system (PCS) and/or an edge (computing) device and/or a cloud (computing) system, for example for the purpose of transmitting (measuring system) data collected by means of the measuring system and/or for remote control and/or for power supply.

The measuring systems in DE-A 102021105397, DE-A 102019009024, DE-A 102020112154, DE-A 102020114519, DE-A 102020118702, DE-A 102020127356, DE-A 102020131452, DE-A 102020132223, DE-A 102020132685, DE-A 102020132686, DE-A 102020132986, DE-A 102020133566, DE-A 102020133614, DE-A 102020133851, WO-A 2019/017891, WO-A 2021121867 are in particular modular vibronic measuring systems (formed by means of a vibronic sensor module). The base module of the modular vibronic measuring systems shown at least in DE-A 102021105397, DE-A 102020112154, DE-A 102020114519, DE-A 102020127356, DE-A 102020131452, DE-A 102020132223, DE-A 102020132685, DE-A 102020132686, DE-A 102020132986, DE-A 102020133566, DE-A 102020133614, DE-A 102020133851, WO-A 2019/017891 or WO-A 2021121867 in each case has a (protective) housing with at least one chamber at least partially wrapped by a housing wall and one or more electric coils, for example cylindrical and/or configured as air coils, which are placed (spaced apart from one another) within the chamber of the (protective) housing and are at least indirectly mechanically connected to the housing wall. Each of the coils is also electrically connected to the converter electronics. The converter electronics can be housed at least partially inside the (protective) housing and/or at least partially outside the (protective) housing, for example in a separate electronics housing. In particular, the base module is also configured to receive the sensor module of the measuring system and to be mechanically firmly connected thereto (forming a vibration-type measuring transducer), but nevertheless releasably connected again, in particular to form the vibronic measuring system itself; this is also done in particular in such a manner that the sensor module is locked in the base module or cannot be moved.

The sensor module of the corresponding measuring system is, as already mentioned, also configured to be replaceable, which in the aforementioned modular vibronic measuring systems is in particular in such a way that it can be introduced into the chamber, in particular also on site, from outside the (protective) housing of the base module or through a (n) (insertion) opening of the housing provided in the housing wall, and that it can be removed from the base module again non-destructively, possibly also without tools, in particular namely from outside the housing and/or can be removed through the (insertion) opening of the housing or without the base module itself having to be handled or removed from the corresponding (process) plant. This also makes it possible, among other things, to insert a sensor module subsequently on site, i.e., into an already installed base module, or to replace a defective or worn sensor module on site with an intact new sensor module, which may only be used once or only for a predetermined period of time (“disposable”).

The sensor module of modular vibronic measuring systems of the aforementioned type furthermore has one or more, for example cylindrical, permanent magnets and is furthermore configured to be installed in the base module in such a way that each of the permanent magnets is placed within the aforementioned chamber, but is nevertheless spaced apart from the housing wall, in particular in such a way that each of the permanent magnets is held in a static installation position predetermined in each case with respect to an alignment and/or a smallest distance from one of the electric coils of the base module and that a corresponding imaginary longitudinal axis of each of the permanent magnets and an imaginary longitudinal axis of at least one of the electric coils are aligned with one another or run parallel to one another in extension. In the aforementioned vibronic measuring systems, each sensor module further has at least one (measuring) tube, for example at least partially straight and/or at least partially curved, with a tube wall forming an outer shell surface of the tube, in particular made of a metal or a plastics material, and with a lumen wrapped by the same tube wall, in particular namely two substantially identical parallel (measuring) tubes, and each of the aforementioned permanent magnets is fixed to the outside of the tube wall, in particular namely to a central segment of the tube wall extending between a first segment end and a second segment end remote therefrom, in particular is connected to the tube wall namely by material bonding. In addition, the sensor module or its at least one (measuring) tube is configured to be installed in the housing, if necessary without tools, in such a way that the tube is placed at least partially, in particular completely, within the chamber, but is nevertheless spaced apart from the housing wall, and that each of the permanent magnets in the corresponding installation position together with the corresponding electric coil form a voice coil, in particular serving as an electrodynamic oscillation exciter, and/or a plunger coil, in particular serving as an electrodynamic oscillation sensor. In the case of a (measuring) tube that is bent at least in portions, the aforementioned central segment can, for example, be substantially U-shaped or V-shaped. In such a modular vibronic measuring system, each of the above-mentioned (measuring) tubes is also configured to carry a fluid measuring substance flowing within the lumen during operation, in particular with a predeterminable flow direction and/or flow direction pointing from the first segment end to the second segment end, and to be vibrated in the meantime in order to generate measuring effects correlated with one or more measured variables of the measuring substance, in particular in such a manner that the central segment performs oscillating movements about a static rest position and/or that the (measuring) tube is driven by means of at least one of the aforementioned (energized) oscillation coils and/or that a (n) (alternating) voltage representing oscillating movements of the at least one tube and thus serving as an oscillation signal is generated by means of the aforementioned plunger coils. The converter electronics of such a measuring system is in turn configured accordingly, by means of an electrical driver signal, in particular with an impressed alternating current and/or an impressed (alternating current) frequency substantially corresponding to a resonant frequency of the at least one tube, to feed electrical power into the at least one electric coil forming the aforementioned voice coil and/or by means of the (alternating) voltage generated by the at least one electric coil forming the aforementioned plunger coil, to determine measurement values for the one or more measured variables to be detected for the measured material flowing through the (measuring) tube or tubes, in the case of a measuring apparatus configured as a Coriolis mass flow meter or measuring apparatus configured as a Coriolis mass flow/density measuring apparatus, for example, to generate (mass flow) measurement values representing the mass flow on the basis of a (measured) phase difference between two of the aforementioned swing signals and a phase difference to measurement value characteristic function set up in the converter electronics. The aforementioned phase difference to measured mass stream characteristic function can, for example, be a (linear) parameter function with a (scale) zero point that corresponds to a (measured) phase difference of the two oscillation signals that can be measured when the measured material is at rest or when the mass stream is zero, and with a slope which corresponds to a (measuring) sensitivity of the measuring system or a change in the (measuring) phase difference related to a change in the mass flow. Since one or more resonance frequencies of the at least one tube are particularly also dependent on the instantaneous density of the corresponding measured substance, by means of such a measuring system, in addition to the mass stream, the density of the corresponding measured substance flowing through it can also be measured directly by means of the (alternating current) frequency of the driver signal and/or by means of a (signal) frequency of at least one of the oscillation signals. Accordingly, the converter electronics of measuring systems of the type in question are typically further equipped to generate (density) measurement values representing the density on the basis of the aforementioned (alternating current) frequency of the driver signal and/or on the basis of a corresponding signal frequency of at least one of the oscillation signals, for example using a characteristic curve function configured accordingly in the converter electronics. Furthermore, it is also possible to directly measure the viscosity of the medium flowing through by means of vibronic measuring systems of the type in question, for example, based on an excitation energy or excitation power required to maintain the useful oscillations and/or based on a damping of the excited (resonance) oscillations resulting from a dissipation of oscillation energy or by using a damping-to-measured value characteristic curve function set up accordingly in the converter electronics. In addition, further measured variables derived from the aforementioned flow and/or substance parameters, such as the Reynolds number, can be easily determined by means of such vibronic measuring systems.

To simplify the putting into service of a modular measuring system, not least also of a modular vibronic measuring system, the sensor module may further have at least one identifying element carrying information relating to or identifying same sensor module, for example a bar code, QR code or radio tag (RFID-TAG) attached to at least one tube and/or the base module can have at least one light-emitting semiconductor element positioned inside the (protective) housing and connected to the converter electronics, for example a light-emitting diode (LED), and/or one or more radio transmitters/receivers (RF transceivers) and/or photosensors, for example one or more CCD photosensors and/or one or more CMOS photosensors, each positioned inside the (protective) housing and connected to the converter electronics.

Measuring systems of the type in question, not least also modular vibronic measuring systems, must also be regularly checked for their functional efficiency or any deviations from a corresponding reference state determined in advance, for example in the state determined by the manufacturer or in the manufacturer's factory and/or during a calibration or putting into service of the corresponding measuring system on site, for example, in order to be able to detect as early as possible any reductions in the functionality or measuring accuracy of the measuring system associated with increased deviations from the reference state, with which the measuring system ultimately maps the measured variable to be recorded, not least the mass flow and density, into the corresponding measurement values. Such reductions in the functionality or measuring accuracy of such a measuring system can occur, for example, in the form of mostly irreversible changes in the electrical impedance of the above-mentioned swing and/or plunger coils and/or a permanently reduced stability of the mechanical connection between the base module and the sensor module or the precision of the positioning of the sensor module in the base module or can be caused, for example, by thermal and/or mechanical overloads, for example as a result of very high or very low temperatures within the base module, ageing, increased or condensing moisture within the base module and/or wear of components of the base module caused by frequent replacement of sensor modules. Other influencing factors that at least indirectly and/or at least temporarily impair the functionality of the measuring system include multi-frequency and/or high-frequency electromagnetic (external) radiation or fields (EMC) propagating within the base module or (external) sound waves propagating within the base module, for example in the form of structure-borne sound.

As a result, it must regularly be assumed that one or more of the system functions (transfer functions) inherent in the measuring system, each of which characterizes a functional dependence of the aforementioned oscillation signals on the corresponding driver signal or one or more functional dependencies of the oscillation signals on the driver signal and the corresponding flow and/or material parameters of the measured substance, is also changed in comparison to a (reference) system function inherent in the corresponding original measuring transducer. Examples of such system functions of a vibronic measuring system include a mass flow to phase difference system function, in accordance with which the aforementioned (measuring) phase difference of the oscillation signals is dependent on the mass flow, or a density to resonance frequency system function of the measuring transducer, in accordance with which one or more 8 resonance frequencies of the at least one tube are dependent on the density of the material to be measured. Equally affected by such (over) loading of the measuring transducer are accordingly also the measuring functions of the measuring system involving the aforementioned system functions, in accordance with which the measuring system as a whole converts the corresponding measured variable to be recorded into the corresponding measurement values, for example a characteristic curve function composed of the aforementioned mass flow to phase difference system function and a phase difference to mass flow measurement value characteristic curve function, namely a characteristic function implemented in the converter electronics, in accordance with which a determined phase difference is converted into mass flow measurement values, mass flow to measurement value measuring function of the measuring system, in accordance with which mass flow measurement values determined thereby are dependent on the mass flow. The phase difference-to-mass flow measurement characteristic curve function can, for example, be a (linear) parameter function with a (scale) zero point corresponding to a (measurement) phase difference measured at rest and a (measurement) sensitivity corresponding to a change in the (measurement) phase difference related to a change in the mass flow (slope of the characteristic curve function). Further examples of such system functions that are also potentially affected by interference or measurement functions formed with them can include a density-to-resonant-frequency-system function of the measuring transducer or a density-to-measured-value-(measurement) function of the measuring system involving this and a resonant-frequency-to-density-measured characteristic function of the converter electronics and/or a viscosity-to-damping-system function of the measuring transducer or a viscosity-to-measured-value-(measuring) function of the measuring system involving this and a damping-to-viscosity-measured-characteristic function of the converter electronics. The change in the corresponding system function can accordingly have an effect, for example, as a drift of one or more of the corresponding characteristic curve parameters of one or more of the aforementioned characteristic curve functions, in the case of a linear parameter function, for example, of its zero point and/or its slope. The above-mentioned, possibly also irreversible changes to one or more of the system or measuring functions of the measuring system can occasionally also lead to the measuring system as a whole working incorrectly to such an extent that the high measuring accuracy aimed for in such typical measuring systems is no longer guaranteed, meaning that the functionality of the measuring system is considerably impaired, possibly even suspended, or that there is a correspondingly critical malfunction of the affected measuring system.

Taking this into account, measuring systems of the type in question are typically subjected to corresponding (re-)inspections, for example at regular intervals in the course of regular or predictive maintenance; in such a manner that the functionality of the sensor module or the totality of the measuring system is checked on site in the course of a time-controlled (self-)diagnosis carried out by means of the measuring system and/or triggered by corresponding control commands transmitted to the converter electronics, approximately in order to be able to initiate appropriate repair or replacement measures as quickly as possible if necessary, for example when a malfunction of the measuring system is detected. In the case of a modular (vibronic) measuring system of the type in question, such a (repair or replacement) measure regularly involves replacing the defective sensor module with a (brand) new sensor module, which can also be carried out quickly and easily on site. However, one disadvantage of a test procedure in such a manner is that only the functionality of the measuring system as a whole can be verified or, conversely, that any malfunction detected cannot be localized exactly within the measuring system, i.e., assigned to the base module, the sensor module or the converter electronics. In particular, it is not readily possible with such a (self-) diagnosis to identify malfunctions of the base module or its converter electronics which merely impair the measuring accuracy, in such a manner that a need to replace the base module and/or the converter electronics can also be determined in the course of such a check of a measuring system of the type in question.

Based on the aforementioned prior art, one object of the invention is to improve the checking or calibration of modular (vibronic) measuring systems in such a manner that any malfunctions or defects of the base module and/or the corresponding converter electronics, not least also signs of wear or ageing of the base module or the converter electronics which reduce the measuring accuracy of the measuring system as a whole, can be detected as early and reliably as possible and, if necessary, also reported.

To solve the problem, the invention consists in a method for (on site) checking and/or putting (back) into service of a modular measuring system used to measure at least one, for example, physical and/or chemical, measured variable, for example a mass flow, a volume flow, a density and/or a viscosity, of a fluid (measurement) medium, for example a liquid, a gas or a dispersion, in particular a modular vibronic measuring system, which measuring system comprises:
a base module (already installed on site) with converter electronics;
and a sensor module that is mechanically (permanently) connected to the base module, for example on site and/or without tools and/or (non-destructively) detachable, and that is coupled to the converter electronics with respect to signal communication, for example that is calibrated in a manufacturer's factory and/or that is vibronic;
wherein the sensor module (connected to the base module) is configured to be contacted by a fluid medium, for example a measurement medium or a calibration medium, for example to be passed around or through, and during this time to set or change at least one (signal) parameter, for example an electrical (signal) voltage, an electrical (signal) current, a (signal) frequency or a (signal) phase, of at least one electrical measurement signal applied to a (measurement) signal input of the converter electronics as a function of at least one measured variable of the medium, for example the at least one measured variable of the measurement medium, for example in such a way that the at least one measurement signal follows a change in the at least one measured variable with a proportional change in the at least one signal parameter within a predetermined measurement range;
and wherein the converter electronics are configured to determine (digital) measurement values for the at least one measured variable using the at least one measured signal and at least one reference (measurement) value determined under reference (calibration) conditions, for example in a manufacturer's factory and/or by means of a (different) (master) base module identical in construction to the base module and/or by means of a (reference) calibration medium brought into contact with the sensor module, for at least one sensor-module-specific calibration parameter, for example a (reference) frequency or a (reference) phase or a (reference) voltage, characterizing, for example, the sensor module or the measuring system (formed in conjunction with the base module);
which method comprises: calibrating the base module using both the sensor module (mechanically connected to the base module and coupled to the converter electronics with respect to signal communication) and the at least one reference (measurement) value for the sensor module-specific calibration parameter, stored for example in the converter electronics.

Furthermore, the invention also consists in a (modular) measuring system, for example that is also configured to perform the method according to the invention and/or that is vibronic, for measuring at least one, for example physical and/or chemical, measured variable, for example a mass flow, a volume flow, a density and/or a viscosity, of a fluid (measurement) medium, for example a liquid, a gas or a dispersion, which measuring system comprises:
a base module with converter electronics;
and a sensor module that is mechanically (firmly) connected to the base module, for example on-site and/or without tools and/or non-destructively, and is coupled to the converter electronics with respect to signal communication, for example calibrated in a manufacturer's factory and/or that is vibronic;
wherein the sensor module (connected to the base module) is configured to be contacted by a fluid medium, for example namely a measurement medium or a calibration medium, for example to be passed around or through, and during this time to adjust at least one (signal) parameter, for example an electrical (signal) voltage, an electrical (signal) current, a (signal) frequency or a (signal) phase, of an electrical measuring signal at a (measurement) signal input of the converter electronics as a function of at least one measured variable of the medium, for example the at least one measured variable of the measurement medium, for example in such a way that the measuring signal follows a change in the at least one measured variable with a proportional change in the at least one signal parameter within a predetermined measurement range;
wherein the converter electronics are configured to determine (digital) measurement values for the at least one measured variable using the at least one measured signal and at least one reference (measurement) value determined under reference (calibration) conditions, for example in a manufacturer's factory and/or by means of a (different) (master) base module identical in construction to the base module and/or by means of a (reference) calibration medium brought into contact with the sensor module, for at least one sensor-module-specific calibration parameter, for example a (reference) frequency, a (reference) phase, a (reference) voltage, characterizing, for example, the sensor module or the measuring system (formed in conjunction with the base module);
and wherein the converter electronics are configured to calibrate the base module using both the sensor module (mechanically connected to the base module and coupled to the converter electronics with respect to signal communication) and the at least one reference (measurement) value for the calibration parameter specific to the sensor module, for example in an automated or program-controlled manner, for example to determine one or more (actual) measurement values for the at least one calibration parameter based on the at least one measured signal (set by the sensor module) and to compare them with the at least one reference measurement value (for the at least one calibration parameter).

According to a first embodiment of the method of the invention, it is further provided that the reference (measurement) value for the at least one calibration parameter is stored (digitally) in a (n) (information) storage element of the sensor module and/or a superordinate electronic data processing system (EDP) (connected to the converter electronics), for example, by means of a programmable logic controller (PLC) and/or a process control system (PCS) and/or an edge (computing) device and/or a cloud (computing) system, and/or in a (n) (on site) control unit for the measuring system.

According to a first development of the method of the invention, this comprises furthermore, reading in data containing the at least one reference (measurement) value and/or identifying or verifying the sensor module, for example stored in a (n) (information) storage element of the sensor module and/or a superordinate electronic data processing system (EDP) connected to the converter electronics, into the converter electronics (immediately) before connecting the sensor module to the base module and/or during the connection of the sensor module to the base module and/or (immediately) after connecting the sensor module to the base module.

According to a second development of the method of the invention, it is further provided that the calibration of the base module further comprises establishing (on site) calibration conditions (of the measuring system), in particular corresponding to the reference (calibration) conditions, in particular namely bringing the sensor module (connected to the base module) into contact with a fluid (calibration) medium having a predetermined (medium) temperature and/or a predetermined (medium) pressure and/or a predetermined volume and/or mass flow. For example, (liquid) water, (water) vapor, air or for example also a (technical) purge gas, in particular air, carbon dioxide, nitrogen and/or argon, can serve as calibration medium.

According to a third development of the method of the invention, it is further provided that the calibration of the base module further comprises performing a (calibration) command, for example, one signaling an establishment of (on site) calibration conditions and/or generated externally of the converter electronics and transmitted to the converter electronics via data transmission, by the converter electronics, for example in such a way that the use of the converter electronics to determine the one or more (actual) measurement values and the comparison thereof with the at least one reference (measurement) value is (only thereby) activated or set in motion. Calibrating the base module can further also comprise, accordingly, a transmission of the (calibration) command to the converter electronics, in particular by actuating a display and operating element (HMI) (of the measuring system) that is coupled to the converter electronics with respect to signal communication and/or (from outside the converter electronics) by means of data transmission.

According to a fourth development of the method of the invention, it is further provided that the calibration of the base module further comprises generating the at least one measurement signal (in a calibration operation of the measuring system or under calibration conditions). The generation of the at least one measurement signal (under calibration conditions) may further comprise, for example, feeding electrical power into the sensor module, in particular into an electric coil of the sensor module, and/or generating a (first) electrical (measuring system) driver signal, in particular with an impressed alternating current and/or with a signal frequency corresponding to a mechanical resonance frequency of the sensor module.

According to a fifth development of the method of the invention, it is further provided that the calibration of the base module further comprises using the converter electronics to determine one or more (actual) measurement values for the at least one calibration parameter on the basis of a measurement signal (generated by means of the measuring system or under calibration conditions).

According to a first embodiment of the fifth development of the method according to the invention, the calibration of the base module further comprises comparing one or more (actual) measurement values with the at least one reference (measurement) value (for the at least one calibration parameter). Developing this embodiment of the invention, it is further provided that comparing the one or more (actual) measurement values with the at least one reference (measurement) value further comprises determining a deviation of the one or more (actual) measurement values from the at least one reference (measurement) value.

According to a second embodiment of the fifth development of the method according to the invention, calibrating the base module further comprises comparing the deviation of the one or more (actual) measurement values from the at least one reference (measurement) value with a predetermined (deviation) threshold value, for example a (deviation) threshold value representing a defective base module and/or serving as a tolerance measure for a (still) intact base module or measuring system and/or as the limit of a tolerance range specified for a (still) intact base module or measuring system and/or dependent on the reference (measurement) value. Developing this embodiment of the invention, it is further provided that exceeding the predetermined (deviation) threshold value initiates or triggers the generation of the (fault) message or blocking of the base module.

According to a third embodiment of the fifth development of the method according to the invention, the comparison of the one or more (actual) measurement values with the at least one reference (measurement) value further comprises determining a (statistical) key figure of the (actual) measurement values, for example, namely determining a position measure of the (actual) measurement values and comparing the position measure with the reference (measurement) value. Developing this embodiment of the invention, it is further provided that the calibration of the base module further comprises a comparison of the (statistical) key figure of the (actual) measurement values, for example a position measure of the (actual) measurement values and/or a scatter measure of the (actual) measurement values, with a predetermined (key figure) threshold value, for example representing a defective base module and/or serving as a tolerance measure for a (still) intact base module or measuring system and/or as the limit of a tolerance range specified for a (still) intact base module or measuring system and/or dependent on the reference (measurement) value. Exceeding the predetermined (key figure) threshold value can also, for example, initiate or trigger the generation of a (fault) message or the blocking of the base module.

According to a fourth embodiment of the fifth development of the method according to the invention, this further comprises a checking of the sensor module using another (second) base module, in particular to verify the plausibility or confirm the (comparison) result (“pass/fail”).

According to a sixth development of the method of the invention, it is further provided that the calibration of the base module further comprises generating the at least one measurement signal (in a calibration operation of the measuring system or under calibration conditions) and comparing one or more (actual) measurement values with the at least one reference (measurement) value (for the at least one calibration parameter), wherein the comparison of the one or more (actual) measurement values with the at least one reference (measurement) value further comprises storing the (comparison) result (“pass/fail”) in a data processing system (EDP) connected with respect to signal communication to the measuring electronics, in particular a programmable logic controller (PLC) and/or a process control system (PCS) and/or an edge (computing) device and/or a cloud (computing) system, for example together with (measurement) data specifying the (on site) calibration conditions and/or together with location and/or (system) time and/or date information (further) specifying the calibration.

According to a seventh development of the method of the invention, it is further provided that calibrating the base module further comprises detecting damage or a defect in the base module. The damage or defect of the base module can be caused, for example, by mechanical wear and/or (mechanical) deformation of the base module and/or faulty (electronic) components or (electronic) assemblies of the converter electronics.

According to an eighth development of the method of the invention, it is further provided that the calibration of the base module further comprises generating a (fault) message (“fail”) signaling a damaged or at least partially defective base module, for example one that is visually perceptible on site, for example if one or more (actual) measurement values determined on the basis of a measurement signal generated (in a calibration operation of the measuring system or under calibration conditions) deviate from the at least one reference (measurement) value (for the at least one calibration parameter) by more than a predetermined tolerance level and/or if a deviation of the one or more (actual) measurement values from the at least one reference (measurement) value and/or a (statistical) key figure of the (actual) measurement values, in particular a position measure of the (actual) measurement values and/or a scatter measure of the (actual) measurement values, lies outside a (corresponding) tolerance range specified for an intact base module or measuring system.

According to a ninth development of the method of the invention, it is further provided that the calibration of the base module further comprises (at least temporarily) blocking the base module for (further) use in a measuring operation (of the measuring system), for example if one or more (actual) measurement values determined on the basis of a measurement signal generated (in a calibration operation of the measuring system or under calibration conditions) deviate from the at least one reference (measurement) value by more than a predetermined tolerance level and/or if a deviation of the one or more (actual) measurement values from the at least one reference (measurement) value and/or a (statistical) key figure of the (actual) measurement values, for example a position measure of the (actual) measurement values and/or a scatter measure of the (actual) measurement values, lies outside a (corresponding) tolerance range specified for an intact base module or measuring system.

According to a first embodiment of the ninth development of the method according to the invention, the (at least temporary) blocking of the base module comprises removing the sensor module from the (blocked) base module. According to a second embodiment of the ninth development of the method according to the invention, the (at least temporary) blocking of the base module comprises connecting the sensor module to a (non-blocked) further (second) base module (on site).

According to a tenth development of the method of the invention, it is further provided that the calibration of the base module further comprises a calibration of the base module further comprises using a further (second) sensor module and/or a test module for repeated checking of the base module, for example if one or more (actual) measurement values determined on the basis of a measurement signal generated (in a calibration operation of the measuring system or under calibration conditions) deviate from the at least one reference (measurement) value by more than a predetermined tolerance level and/or if a deviation of the one or more (actual) measurement values from the at least one reference (measurement) value and/or a (statistical) key figure of the (actual) measurement values lies outside a (corresponding) tolerance range specified for an intact base module or measuring system, and/or (immediately) after the generation of the (fault) message or blocking of the base module.

According to an eleventh development of the method of the invention, it is further provided that the calibration of the base module further comprises releasing the base module for (further) use in a measuring operation (of the measuring system) or for determining measurement values for the at least one measured variable (in the measuring operation), for example if one or more (actual) measurement values determined on the basis of a measurement signal generated (in a calibration operation of the measuring system or under calibration conditions) do not deviate from the at least one reference (measurement) value or deviate by less than a predetermined tolerance value; this applies in particular in the event that none of the one or more (actual) measurement values deviates from the at least one reference (measurement) value by more than the tolerance value, and/or that a deviation of the one or more (actual) measurement values from the at least one reference (measurement) value and/or a (statistical) key figure of the (actual) measurement values, for example a position measure of the (actual) measurement values and/or a scatter measure of the (actual) measurement values, lies within a (corresponding) tolerance range specified for an intact base module or measuring system. Alternatively or additionally, releasing the base module may also comprise or enable the use of the at least one reference (measurement) value for the at least one calibration parameter (in the measuring operation of the measuring system) to determine measurement values for the at least one measured variable.

According to a twelfth development of the method of the invention, this comprises furthermore forming the measuring system by (mechanically) connecting the sensor module to the base module (already installed on site), for example by inserting the sensor module into the base module (already installed on site) and/or (immediately) after a (re-)loosening and removal of another sensor module (identical to the sensor module and/or used) from the base module.

According to a thirteenth development of the method of the invention, this comprises furthermore integrating the sensor module into a line system used to guide a flowing fluid (measurement) medium, for example (immediately) before the calibration of the base module and/or (immediately) before the connection to the base module.

According to a fourteenth development of the method of the invention, this comprises furthermore integrating the converter electronics or the measuring system formed thereby into a superordinate electronic data processing system (EDP), for example formed by means of a programmable logic controller (PLC) and/or a process control system (PCS) and/or an edge (computing) device and/or a cloud (computing) system.

According to a fifteenth development of the method of the invention, this further comprises transmitting and storing the at least one reference (measurement) value for the at least one calibration parameter in the converter electronics, in particular together with reference (measurement) data specifying the reference (calibration) conditions.

According to a sixteenth development of the method of the invention, this further comprises installing the base module in a plant, for example, installing the base module in a (plant) cabinet of the plant or a (plant) frame of the plant and/or (electrical) connecting the converter electronics to a (superordinate) electronic (plant) data processing system (EDP) of the plant.

According to a seventeenth development of the method of the invention, this furthermore comprises checking, especially verifying or authenticating, the sensor module, especially before the calibration of the base module.

According to a first embodiment of the seventeenth development of the method according to the invention, checking the sensor module comprises verifying or authenticating the sensor module, for example using the converter electronics and/or a (n) (information) storage element of the sensor module and/or a superordinate electronic data processing system (EDP) connected to the converter electronics.

According to a second embodiment of the seventeenth development of the method according to the invention, the checking of the sensor module comprises checking whether the sensor module is suitable for forming the measuring system and/or calibrating the base module, in particular whether it is (still) approved, for example by means of a (n) (electronic) certificate and/or a (n) (electronic) seal and/or using the converter electronics and/or a (n) (information) storage element of the sensor module and/or a superordinate electronic data processing system (EDP) connected to the converter electronics.

According to a third embodiment of the seventeenth development of the method according to the invention, the checking of the sensor module comprises checking a (n) (electronic) seal of the sensor module, for example using the converter electronics and/or a (n) (on-site) control unit for the measuring system.

According to a fourth embodiment of the seventeenth development of the method according to the invention, checking the sensor module involves releasing the sensor module for forming the measuring system and calibrating the base module, if the sensor module is approved for this purpose, for example using the converter electronics and/or based on a (n) (electronic) certificate of the sensor module.

According to an eighteenth development of the method of the invention, this comprises furthermore blocking the sensor module for recalibration of the base module, in particular by annulling a certificate of the sensor module (which serves to verify or authenticate the sensor module) during or after checking of the sensor module.

According to a nineteenth development of the method of the invention, this comprises furthermore blocking the sensor module for calibration of another base module, in particular by annulling a certificate of the sensor module (which is used to verify or authenticate the sensor module) during or after checking of the sensor module.

According to a first embodiment of the measuring system of the invention, it is further provided that the converter electronics are configured to calibrate the base module by determining one or more (actual) measurement values for the at least one calibration parameter based on the at least one measurement signal (set by the sensor module) and comparing them with the at least one reference measurement value (for the at least one calibration parameter).

According to a second embodiment of the measuring system of the invention, it is further provided that the converter electronics are configured to calibrate the base module by determining one or more (actual) measurement values for the at least one calibration parameter based on the at least one measurement signal (set by the sensor module) and comparing them with the at least one reference measurement value (for the at least one calibration parameter), as well as generating a (fault) message (“fail”) signaling a damaged or at least partially defective base module and/or blocking the base module for (further) use in a measuring operation (of the measuring system); this applies in particular if one or more (actual) measurement values deviate from the at least one reference (measurement) value by more than a predetermined tolerance value and/or that a deviation of the one or more (actual) measurement values from the at least one reference (measurement) value and/or a (statistical) key figure of the (actual) measurement values, in particular a position measure of the (actual) measurement values and/or a scatter measure of the (actual) measurement values, lies outside a (corresponding) tolerance range specified for an intact base module or measuring system.

According to a third embodiment of the measuring system of the invention, it is further provided that the converter electronics are configured to calibrate the base module by determining one or more (actual) measurement values for the at least one calibration parameter based on the at least one measurement signal (set by the sensor module) and comparing them with the at least one reference measurement value (for the at least one calibration parameter), and to release the base module for (further) use in a measuring operation (of the measuring system) or for determining measurement values for the at least one measured variable (in the measuring operation); this applies in particular if one or more (actual) measurement values deviate from the at least one reference (measurement) value by less than a predetermined tolerance value, in particular if none of the one or more (actual) measurement values deviates from the at least one reference (measurement) value by more than the tolerance value, and/or if a deviation of the one or more (actual) measurement values from the at least one reference (measurement) value and/or a (statistical) key figure of the (actual) measurement values, in particular a position measure of the (actual) measurement values and/or a scatter measure of the (actual) measurement values, lies within a (corresponding) tolerance range specified for an intact base module or measuring system.

According to a fourth embodiment of the measuring system of the invention, it is further provided that the sensor module or the measuring system formed thereby is (detachably) integrated into a line system serving to guide the fluid (measurement) medium, in particular at least temporarily flowing, in particular is integrated into the course of a (measuring substance) line of the line system.

According to a fifth embodiment of the measuring system of the invention, it is further provided that the converter electronics or the measuring system formed thereby is integrated into a superordinate electronic data processing system (EDP), in particular formed by means of a programmable logic controller (PLC) and/or a process control system (PCS) and/or an edge (computing) device and/or a cloud (computing) system, in particular is connected to the superordinate electronic data processing system with respect to signal and data communication. Developing this embodiment of the invention, it is further provided that the converter electronics is arranged to communicate via a data line and/or by radio with the superordinate electronic data processing system, in particular in order to perform, in co-operation, the calibration of the base module and/or putting (back) into service of the measuring system in an automated manner and/or in dialogue with a user of the measuring system.

According to a sixth embodiment of the measuring system of the invention, it is further provided that the converter electronics has at least one data output for outputting the (fault) message.

According to a seventh embodiment of the measuring system of the invention, it is further provided that the converter electronics has a radio unit, in particular for transmitting (measuring system) data and/or for receiving the at least one (reference) measurement value.

According to an eighth embodiment of the measuring system of the invention, it is further provided that the converter electronics has at least one data input for receiving the at least one (reference) measurement value.

According to a ninth embodiment of the measuring system of the invention, it is further provided that the converter electronics is arranged to receive the at least one reference (measurement) value for the at least one calibration parameter, in particular together with reference (measurement) data specifying the reference (calibration) conditions, in particular to read it out from a (n) (information) storage element of the sensor module and/or to receive it from a superordinate electronic data processing system (EDP) (connected to the converter electronics with respect to signal and data communication) and/or a display and operating element connected to the measuring electronics with respect to signal communication.

According to a tenth embodiment of the measuring system of the invention, it is further provided that the converter electronics are arranged to store, in particular in a non-volatile manner, the at least one reference (measurement) value for the at least one calibration parameter, in particular received externally, in particular together with reference (measurement) data specifying the reference (calibration) conditions.

According to an eleventh embodiment of the measuring system of the invention, it is further provided that the converter electronics is arranged to store a (comparison) result (“pass/fail”) of the comparison of the one or more (actual) measurement values with the at least one reference (measurement) value, in particular together with (measuring system) data specifying the (on-site) calibration conditions and/or together with location and/or (system) time and/or date information (further) specifying the comparison.

According to a twelfth embodiment of the measuring system of the invention, it is further provided that the converter electronics is arranged to receive a (calibration) command, in particular one signaling the establishment of the (on site) calibration conditions and/or generated externally of the converter electronics and transmitted to the converter electronics via data transmission, from a superordinate electronic data processing system (EDP) (connected to the converter electronics with respect to signal and data communication) and/or to receive, in particular namely to receive and execute, a display and operating element, in particular a (n) (on site) control unit connected to the measuring electronics with respect to signal communication.

According to a thirteenth embodiment of the measuring system of the invention, it is further provided that the converter electronics is arranged to execute a (calibration) command, in particular one signaling the establishment of the (on site) calibration conditions and/or generated externally of the converter electronics and transmitted to the converter electronics via data transmission, in particular in such a way that the use of the converter electronics to determine the one or more (actual) measurement values and the comparison thereof with the at least one reference (measurement) value is (only thereby) activated or set in motion.

According to a fourteenth embodiment of the measuring system of the invention, it is further provided that the converter electronics are configured to feed electrical power into the sensor module, in particular an electric coil of the base module, by means of a (first) electrical (measuring system) driver signal, in particular with an impressed alternating current. Developing this embodiment of the invention, the converter electronics are further configured to provide the (first) electrical (measuring system) driver signal with a signal frequency corresponding to a mechanical resonance frequency of the sensor module.

According to a fifteenth embodiment of the measuring system of the invention, it is further provided that the sensor module and the base module are configured to be assembled (on site) without tools and/or to be disassembled (without tools) non-destructively.

According to a sixteenth embodiment of the measuring system of the invention, the converter electronics are configured to determine measurement values for at least one measured variable of a (fluid) measurement medium flowing through the first tube using at least one first (alternating) voltage, in particular induced in an electric coil (of the sensor module).

According to a seventeenth embodiment of the measuring system of the invention, it is further provided that the base module is configured to receive the sensor module and to be connected thereto in a mechanically fixed, but nevertheless releasable manner, in particular namely by forming a measuring transducer of the vibration type or a vibronic measuring system and/or in such a manner that the sensor module is immovably locked on and/or in the base module.

According to an eighteenth embodiment of the measuring system of the invention, it is further provided that the base module has at least one first electric coil, for example placed within a chamber of a (protective) housing of the base module and/or cylindrical and/or configured as an air coil and/or electrically connected to the measuring signal input of the converter electronics (by means of connecting wires). Developing this embodiment of the invention, it is further provided that a (first) (alternating) voltage induced (by means of the sensor module) in the first electric coil serves as (signal) voltage of the measuring signal and/or that the sensor module is configured to induce an electrical (alternating) voltage (serving as signal voltage of the measuring signal) in the first electric coil.

According to a nineteenth embodiment of the measuring system of the invention, it is further provided that the base module has at least one first electric coil, for example placed within a chamber of a (protective) housing of the base module and/or cylindrical and/or configured as an air coil and/or electrically connected to the measurement signal input of the converter electronics (by means of connecting wires), and at least one second electric coil, for example placed within a chamber of a (protective) housing of the base module and/or cylindrical and/or identical in construction to the first electric coil and/or positioned away from the first electric coil and/or electrically connected to the converter electronics. Developing this embodiment of the invention, it is further provided that the base module has at least one third electric coil, for example placed within a chamber of a (protective) housing of the base module and/or cylindrical and/or structurally identical to the first and/or second electric coil and/or positioned away from the first and/or second electric coil and/or electrically connected to the converter electronics.

According to a twentieth embodiment of the measuring system of the invention, it is further provided that the measuring system is a Coriolis mass flow meter, in particular a Coriolis mass flow/density meter and/or a Coriolis mass flow/viscosity meter.

According to a twenty-first embodiment of the measuring system of the invention, it is further provided that the sensor module has at least one, in particular cylindrical, first permanent magnet. Developing this embodiment of the invention, it is further provided that the base module has at least one first electric coil, for example placed within a chamber of a (protective) housing of the base module and/or cylindrical and/or configured as an air coil and/or electrically connected to the measurement signal input of the converter electronics (by means of connecting wires), and the sensor module is connected to the base module in such a way that the first permanent magnet is held in a static (first) installation position predetermined with regard to an alignment and/or a smallest distance from the first electric coil and/or that an imaginary longitudinal axis of the first permanent magnet and an imaginary longitudinal axis of the first electric coil are aligned with one another or extend parallel to one another; this is also the case, for example, in such a way that the first permanent magnet, in the installation position, together with the first electric coil forms a moving coil, in particular serving as an electrodynamic oscillation exciter, and/or a plunger coil, in particular serving as an electrodynamic oscillation sensor.

According to a twenty-second embodiment of the measuring system of the invention, it is further provided that the base module has a (protective) housing with at least one chamber at least partially wrapped by a housing wall, and that the sensor module is configured to be replaceable, in such a way that it can be introduced into the chamber from outside the (protective) housing of the base module and/or through a (n) (insertion) opening of the (protective) housing provided in the housing wall and that it can be removed again from the base module, in particular non-destructively and/or without tools, in particular namely from outside the housing and/or can be removed through the (insertion) opening of the (protective) housing. Developing this embodiment of the invention, it is further provided that the base module has at least one (first) electric coil placed within the chamber, for example cylindrical and/or configured as an air coil and/or electrically connected to the measurement signal input of the converter electronics (by means of connecting wires), which is at least indirectly mechanically connected to the housing wall and/or placed within the chamber, but is nevertheless spaced apart from the housing wall; this, for example, in such a way that the at least one electric coil is held in a static (first) installation position predetermined with regard to an alignment and/or a smallest distance from the first electric coil.

According to a twenty-third embodiment of the measuring system of the invention, it is further provided that the sensor module has at least one (first) tube, in particular at least partially straight and/or at least partially curved, with a tube wall forming an outer shell surface of the tube, for example made of a metal or a plastics material, and with a lumen wrapped by the same tube wall, in an at least one, in particular cylindrical, first permanent magnet, wherein the first permanent magnet is fixed to the outside of the tube wall, in particular to a central segment of the tube wall extending between a first segment end and a second segment end remote therefrom, in particular is connected to the tube wall by material bonding. Developing this embodiment of the invention, it is further provided that the base module has a (protective) housing with at least one chamber at least partially wrapped by a housing wall and that the sensor module is configured to be replaceable in such a way that it can be introduced into the chamber from outside the (protective) housing of the base module and/or through a (n) (insertion) opening of the (protective) housing provided in the housing wall and that it can be removed again from the base module, in particular non-destructively and/or without tools, in particular from outside the housing and/or through the (insertion) opening of the (protective) housing, wherein the sensor module is installed in the (protective) housing in such a way that the (first) tube is at least partially, in particular completely, placed within the chamber, but is nevertheless spaced apart from the housing wall. Alternatively or in addition, the sensor module can further have, for example, at least one second permanent magnet, in particular cylindrical and/or identical in construction to the first permanent magnet, in particular a second permanent magnet and a third permanent magnet. In addition, the second permanent magnet can be fixed, in particular away from the first permanent magnet, on the outside of the central segment of the tube wall of the first tube, in particular namely can be connected thereto by material bonding, and/or the base module can be configured to receive the sensor module in such a way that the second permanent magnet is held in a second installation position, in particular remote from the first installation position, in particular namely such that an imaginary longitudinal axis of the second permanent magnet and an imaginary longitudinal axis of a second electric coil (of the base module) are aligned with one another or are parallel to one another in extension.

According to a first development of the measuring system of the invention, the sensor module has at least one (first) tube, in particular at least partially straight and/or at least partially bent, with a tube wall forming an outer shell surface of the tube, for example made of a metal or a plastics material, and with a lumen wrapped by the same tube wall. According to a first embodiment of the first development of the measuring system according to the invention, the (first) tube is U-shaped or V-shaped at least in portions. According to a second embodiment of the first development of the measuring system according to the invention, the (first) tube is configured to be passed through by a fluid medium and to be vibrated during this process, in particular in such a way that a first (alternating) voltage induced (using the sensor module) in the first electric coil represents oscillatory movements of the first tube.

According to a third embodiment of the first development of the measuring system according to the invention, the (first) tube is configured to guide a fluid measuring substance flowing in its lumen, in particular with a predeterminable flow direction and/or pointing from a (n) (inlet-side) first segment end to a (n) (outlet-side) second segment end, in particular to be vibrated in the process.

According to a fourth embodiment of the first development of the measuring system according to the invention, (first) the tube is configured to be vibrated, in particular driven by a oscillation exciter formed by means of the first electric coil and the first permanent magnet, in particular in such a way that at least one central segment of the tube wall extending between a first segment end and a second segment end remote therefrom executes oscillation movements about a static rest position and/or that the first (alternating) voltage represents oscillation movements of the central segment.

According to a fifth embodiment of the first development of the measuring system according to the invention, the sensor module has at least one, in particular cylindrical, first permanent magnet, wherein the first permanent magnet is fixed to a central segment of the tube wall extending between a first segment end, in particular on the inlet side, and a second segment end remote therefrom, in particular on the outlet side.

According to a sixth embodiment of the first development of the measuring system according to the invention, the converter electronics are configured to determine measurement values for at least one measured variable of a (fluid) measurement medium flowing through the (first) tube using a first (alternating) voltage induced in particular in an electric coil (of the sensor module).

According to a second development of the measuring system of the invention, the sensor module has a first tube, in particular a first tube which is straight at least in portions and/or bent at least in portions, with a tube wall forming an outer shell surface of the tube, for example made of a metal or a plastics material, and with a lumen wrapped by the same tube wall, at least one second tube, in particular identical in construction and/or function to the first tube, with a tube wall forming an outer shell surface of the second tube, in particular made of a metal or a plastics material, and with a lumen wrapped by the same tube wall, and a first permanent magnet, in particular a cylindrical one, wherein the first permanent magnet is fixed to the outside of the tube wall, in particular to a central segment of the tube wall extending between a first segment end and a second segment end remote therefrom, in particular is connected by material bonding to the tube wall. According to an advantageous embodiment of the second development of the measuring system according to the invention, the sensor module further comprises at least one second permanent magnet, in particular a cylindrical one and/or one structurally identical to the first permanent magnet, in particular a second permanent magnet and a third permanent magnet. The second permanent magnet, for example, in particular vis-a-vis the first permanent magnet fixed to the first tube, can be fixed to the second tube, in particular can be connected thereto by material bonding, in particular in such a way that an imaginary longitudinal axis of the second permanent magnet and an imaginary longitudinal axis of the first permanent magnet are aligned with one another or extend parallel to one another in extension. Alternatively, the second permanent magnet can also be fixed to the first tube, in particular namely by material bonding, away from the first permanent magnet, in particular in such a way that an imaginary longitudinal axis of the second permanent magnet and an imaginary longitudinal axis of the first permanent magnet run parallel to one another.

According to a third development of the measuring system of the invention, this system further comprises a display and/or operating element.

A basic idea of the invention is, among other things, to calibrate or check the base module of modular measuring systems, not least modular vibronic measuring systems, in a simple, yet reliable way on a recurring basis (on site) by using the (brand-new) sensor module newly connected (in exchange for a previously used sensor module) to the base module (already installed on-site) in order to form a new measuring system, together with one or more reference (measurement) values available in the converter electronics, for example, collected by means of factory calibration, for one or more sensor module-specific calibration parameters namely of said (brand-new) sensor module first (as a reference standard) for checking or calibrating the base module (already installed on-site), before using it in the actual measuring operation. In the case of sensor modules to be used only once or only for a predetermined period of time (“single-use”), such a (n) (on-site) check can also be carried out advantageously as part of a planned or regular replacement of the sensor module previously installed in the corresponding base module (already installed on-site) with a (brand) new sensor module. One advantage of the invention is that it allows a base module or measuring system electronics of a modular measuring system to be checked in a very simple manner on-site, as necessary also in a (partially) automated manner or also by the operator of the measuring system (self-service), in particular also in situ or without having to remove the already installed (on-site) base module or the already installed (on-site) measuring system electronics.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, in particular combinations of partial aspects of the invention that were initially explained only separately, furthermore emerge from the figures of the drawing and/or from the claims themselves.

In the figures in detail:

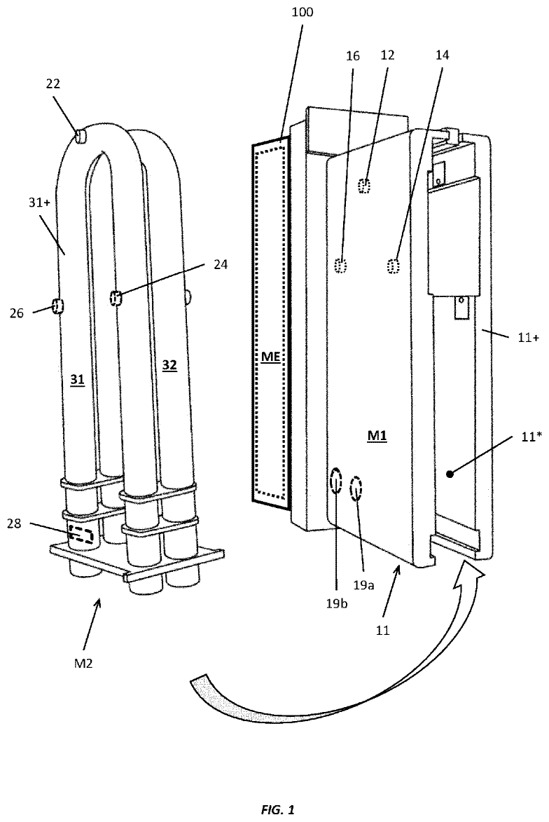

FIG. 1, 2 show an exemplary embodiment of a base module, a measuring system electronics and a vibronic module of a modular (vibronic) measuring system (still to be assembled); and

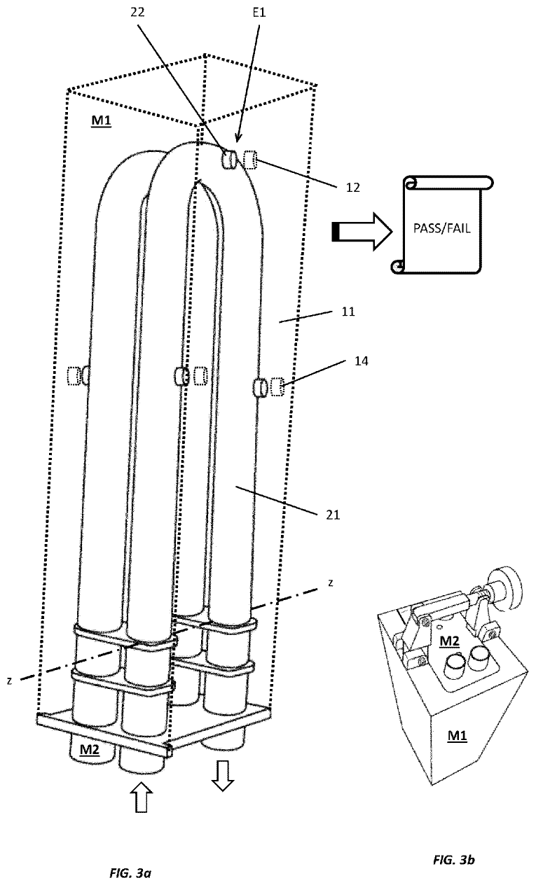

FIG. 3a, 3b show different side views of an exemplary embodiment of the modular measuring system in accordance with FIG. 1.

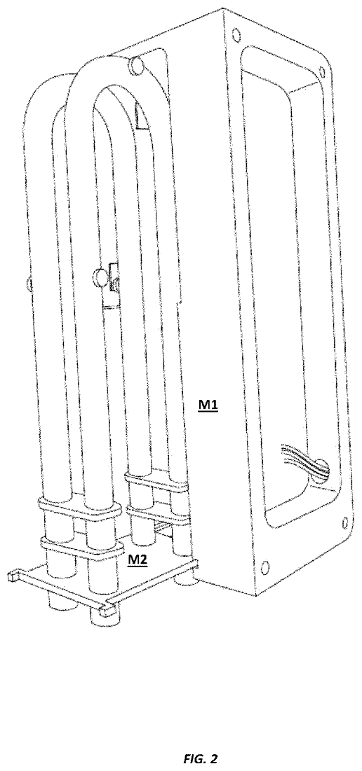

FIGS. 1, 2, 3a and 3b schematically show an exemplary embodiment of a modular measuring system which is particularly intended to record at least one measured variable of a fluid measuring substance or (measuring) medium flowing at least temporarily, for example in a (measuring substance) line, for example a hose line or a pipeline, or a line system (formed by means of such a line), namely to determine measurement values for one or more measured variables, for example a mass flow, a volume flow, a density, a viscosity, a temperature, a pressure, a pH value, etc., of the (measuring) medium (or measuring substance). The (measuring) medium can be, for example, a gas, a liquid, for example (highly purified) water, or a dispersion. The measuring system, which is configured accordingly, for example, as a (n) (industrial) mass flow, volume flow, density, viscosity, temperature, pressure or pH value measuring device, comprises a (n) (already installed on-site) base module M1 with a converter electronics ME, for example formed by one or more microprocessors (μC) and/or digital signal processors (DSP) and/or (re-)programmable, as well as a sensor module M2 (already calibrated before merging with the base module or externally of the measuring system). The measuring system can also be configured, for example, as a modular vibronic measuring system, in particular as a modular Coriolis mass flow meter, a modular Coriolis mass flow/density meter and/or as a modular Coriolis mass flow/viscosity meter, thus can correspond to one of the modular measuring systems described in the patent applications mentioned at the outset WO-A 2019/017891, WO-A 2021121867, WO-A 2022/242975, DE-A 102021105397, DE-A 102020133614, DE-A 102020132685, DE-A 102020133851, DE-A 102020133566, DE-A 102020132986, DE-A 102020132686, DE-A 102020132685, DE-A 102020131452, DE-A 102020132223, DE-A 102020127356, DE-A 102020114519, DE-A 102020112154, DE-A 102019009024 or DE-A 102020118702 or in the (not pre-published) international patent application PCT/EP2022/076349. The base module can also, for example, be installed (permanently) in an industrial, for example process engineering, pharmaceutical or biotechnological, (process) plant, for example be built into a (plant) cabinet of the plant or a (plant) frame of the plant.

The converter electronics (or the measuring system formed thereby) can also advantageously be (permanently) integrated into a superordinate electronic data processing system (EDP), for example formed by a programmable logic controller (PLC) and/or a process control system (PCS) and/or an edge (computing) device and/or a cloud (computing) system—not least for the purpose of transmitting (measuring system) data collected by the measuring system, such as measurement values determined for one or more measured variables, and/or for remote control—in particular be electrically connected to the superordinate electronic data processing system or be integrated accordingly (in terms of signals and data) before the start of the actual measuring operation, for example via a standardized (field) bus system (PROFIBUS, FOUNDATION FIELDBUS, HART, MODBUS, EtherNET Powerlink, EtherCAT, IO-Link, SPE, APL etc.). Accordingly, the converter electronics ME can further be configured to communicate with the superordinate electronic data processing system via a data line 2L and/or wirelessly, for example by means of WirelessHART, wirelessPROFIBUS, WLAN, LTE, etc., for example to send (measuring system) data to the superordinate electronic data processing system and/or to receive (setting) values for (setting) parameters configuring the converter electronics or commands (controlling the converter electronics). According to a further embodiment of the invention, the converter electronics has at least one data input and/or a radio unit and/or the converter electronics is further configured to control or perform a putting (back) into service of the measuring system in an automated manner and/or in dialogue with a user of the measuring system and/or in conjunction with the superordinate electronic data processing system. In addition, the converter electronics can have at least one data output for outputting (measuring system) data, in particular digital and/or time-stamped data, for example measurement and/or operating values characterizing the converter electronics and/or measurement and/or operating values characterizing the base module, to the superordinate electronic data processing system. Alternatively or in addition, the converter electronics or the measuring system formed thereby can also be supplied with electrical energy from an external mains supply, possibly also implemented by the aforementioned superordinate electronic data processing system.

To operate the measuring system on-site or to display (measurement and/or operating) data generated by the measuring system, in particular measurement values for the at least one measured variable, and/or (status) messages of the measuring system, the measuring system can further comprise a display or display and operating element HMI that is electrically connected to the converter electronics, for example formed by a touch display, and/or an external (on-site) operating device that is (only temporarily) connected to the converter electronics, for example to its aforementioned data input and/or to its aforementioned data output, can be used.

The sensor module M2 is (when installed or during operation of the measuring system) mechanically (permanently) connected to the base module M1 and also coupled to the converter electronics in terms of signal technology; this is done in particular in such a way that said sensor module M2 has been mechanically connected to the base module M2 on site, for example without tools, and/or in such a way that the sensor module M2 can be detached from the base module M1 (non-destructively). Base module M1 and sensor module M2 can also be advantageously provided or configured so that the sensor module M2 can also be used on site, namely (subsequently) in the base module already installed (in a plant), meaning that the corresponding measuring system can also be created by assembling the base and sensor modules on site, for example without tools and/or without having to handle the base module M1 itself or remove it from the corresponding (process) plant. The base module M1 can, as is readily apparent, advantageously also be configured to receive the sensor module M2 and to be connected thereto in a mechanically fixed but releasable manner such that the sensor module M2 is not movably held or locked in the base module M1. According to a further embodiment of the invention, the sensor module M2 and the base module M1 are further configured to be disassembled again, in particular on site, without tools, in particular non-destructively, in particular in such a way that the sensor module can be removed again from the base module M1 without having to handle the base module M1 itself or remove it from the corresponding (process) system. As a result, it is now possible, among other things, to easily replace a defective or worn (old) sensor module on-site with an intact, new sensor module (M2), which may only be used for a limited number of batches or only once and/or only for a predetermined period of time (“single use,” “disposable”). Accordingly, a forming of the measuring system or a putting (back) into operation of the measuring system, for example, also (immediately) following a (re-) loosening and removal or disassembly of another sensor module (identical to the sensor module and/or used) from the base module and/or immediately preceding the determination of measurement values, can comprise a (mechanical) connection of the sensor module to the base module (installed in the above-mentioned plant), for example namely by inserting or installing the sensor module into the base module, as well as an integration of the sensor module into the aforementioned line system used to guide the flowing fluid (measuring) medium, for example also (immediately) before connection to the base module.

According to a further embodiment of the invention, the base module M1 has a (protective) housing 11 with at least one chamber 11* (for the sensor module M2) which is at least partially wrapped by a housing wall 11+, and the sensor module M2 is configured such that it can be introduced into the chamber 11* of the (protective) housing 11 from outside the (protective) housing 11 and/or through a (n) (insertion) opening provided in the housing wall 11+ thereof; this, as already mentioned, for example, without having to handle the base module M1 itself or remove it from the corresponding (process) plant. Advantageously, the base module M1 and the sensor module M2 can also be configured such that the sensor module M2 can be removed from the base module M1, in particular non-destructively and/or without tools, by being removable from outside the housing 11 and/or through the (insertion) opening of the (protective) housing 11, for example without having to handle the base module M1 itself or remove it from the corresponding (process) system. The aforementioned (insertion) opening of the housing 11 can also, if necessary, be sealed after installation of the sensor module and/or after disassembly thereof by means of an appropriate cover, for example also dust-tight and/or tight against strong water jets and/or explosion-proof. In addition to the sensor module, the converter electronics ME, which may also be modular, can also be accommodated at least partially within the chamber 11*. Alternatively or in addition, the converter electronics ME can also be accommodated at least partially outside the chamber 11*, for example within an additional electronics chamber 100 of the base module M1.

In order to support correct installation of the sensor module M2 into the base module M1, the sensor module M2 and base module M1 can each have corresponding guide structures or elements, for example corresponding (guide) grooves in one of the two modules (M1, M2) and (guide) springs and/or (guide) pins in the other of the two modules that slide therein during assembly. To simplify putting into service of the measuring system (completed on site), the sensor module M2 can also have at least one (information) storage element 28, for example a barcode, QR code or radio tag (RFID tag), which carries information relating to or identifying the sensor module M2. Advantageously, the base module M1 furthermore to read out said (information) storage element 28 can have at least one light-emitting semiconductor element 19a connected to the converter electronics (in the direction of the sensor module), for example a light-emitting diode (LED), and/or one or more radio transmitters/receivers (RF transceivers) and/or photosensors 19b connected to the converter electronics, for example one or more CCD photosensors and/or one or more CMOS photosensors.

The sensor module M2 of the measuring system according to the invention (connected to the base module M1 and optionally integrated into the aforementioned line system) is particularly configured to be contacted by a fluid medium, for example the aforementioned measurement medium or else a calibration medium (serving to calibrate the measuring system), for example to be passed around or through, and during this time to set or change at least one (signal) parameter, for example an electrical (signal) voltage, an electrical (signal) current, a (signal) frequency or a (signal) phase, of at least one electrical, for example capacitive or for example inductive, measuring signal applied to a (first) (measurement) signal input of the converter electronics as a function of at least one measured variable of the medium (contacting the sensor module in each case); this is done, for example, in such a way that the at least one measurement signal follows a change in the at least one measured variable with a proportional change in the at least one signal parameter within a predetermined measurement range. The sensor module can accordingly be formed, for example, by means of a rod probe that can be introduced into the aforementioned line, for example according to DE-A 102008029956. Alternatively, the sensor module can also be formed by means of one or more (measuring) tubes that can be introduced into the course of the aforementioned line or a shunt line, thus the sensor module can also correspond to one of the (vibronic) sensor modules shown in WO-A 2019/017891, WO-A 2021121867, WO-A 2022/242975, DE-A 102021105397, DE-A 102020133614, DE-A 102020132685, DE-A 102020133851, DE-A 102020133566, DE-A 102020132986, DE-A 102020132686, DE-A 102020132685, DE-A 102020131452, DE-A 102020132223, DE-A 102020127356, DE-A 102020114519, DE-A 102020112154, DE-A 102019009024, DE-A 102020118702 or DE-A 102008029956 mentioned at the outset or also in the (not pre-published) international patent application PCT/EP2022/076349. According to a further embodiment of the invention, the sensor module M2 accordingly has at least one (first) tube 31 with a tube wall forming an outer shell surface of the tube 31, for example made of a metal or a plastics material, and with a lumen 21* wrapped by the same tube wall, and/or the sensor module M2 is further configured to set or change at least one (signal) parameter, for example an electrical (signal) voltage, an electrical (signal) current, a (signal) frequency or a (signal) phase, of at least one electrical, for example capacitive or for example also inductive, second measurement signal applied to a second (measurement) signal input of the converter electronics as a function of at least one measured variable of the medium (contacting the sensor module in each case); this can also be done, for example, simultaneously with the at least one (signal) parameter of the first measurement signal and/or in such a way that the second measurement signal follows a change in the at least one measured variable with a proportional change in the at least one signal parameter within a predetermined measurement range. According to a further embodiment of the invention, the sensor module is configured to set or change the first and second measurement signals in such a way that a phase difference established between said measurement signals, namely a difference between a (signal) phase of the first measurement signal and a (signal) phase of the second measurement signal, has a (proportional) dependence on the mass flow of the medium flowing through the sensor module and/or that at least one of the measurement signals has a (signal) frequency dependent on a density of the medium contacting the sensor module (or guided therein).

As shown schematically in FIG. 1, the aforementioned at least one (measuring) tube 31 can be straight at least in portions and/or curved at least in portions, for example in such a way that a central segment of the tube wall extending between a first segment end and a second segment end of the tube wall remote therefrom is designed to be U-shaped or V-shaped. The at least one tube 31 is, as already indicated, also intended, among other things, to be integrated into the course of the aforementioned (measuring substance) line. In addition, the at least one (measuring) tube 31 is particularly configured to conduct a fluid medium, for example the aforementioned measurement medium, in its lumen, in particular at least temporarily with a predeterminable flow direction, for example pointing from the aforementioned first segment end to the aforementioned second segment end, for example, namely via the aforementioned (measuring substance) line, in or out accordingly. According to a further embodiment of the invention, the at least one (measuring) tube 31 is also configured to be vibrated, in particular while the aforementioned medium is guided in the lumen of the tube or flows through said lumen.

The converter electronics of the measuring system according to the invention is also particularly configured to determine (digital) measurement values for the at least one measured variable using the at least one (first) measured signal, for example also using both the first measured signal and the aforementioned second measured signal, as well as at least one reference (measurement) value determined (in advance) under reference (calibration) conditions for at least one sensor module-specific calibration parameter, in particular a (reference) frequency or a (reference) phase or a (reference) voltage, characterizing the (correspondingly calibrated) sensor module or the measuring system (formed in conjunction with the base module); this in particular in such a way that the reference (measurement) value serves as a parameter value of a (converter) characteristic function implemented in the converter electronics, according to which (in the measuring mode of the measuring system), based on the at least one measuring signal or its previously designated at least one (signal) parameter, the measurement values for the at least one measured variable are determined or calculated, or instantiates a coefficient of the aforementioned (converter) characteristic function. Said reference (measurement) value of the at least one (sensor module-specific) calibration parameter can, for example, be determined in a manufacturer's factory (before the sensor module is sent to the operator of the measuring system) and/or by means of a (different) (master) base module identical in construction to the base module and/or by means of a (reference) calibration medium brought into contact with the sensor module, for example in a corresponding, possibly also accredited calibration laboratory or on a corresponding, possibly also accredited calibration plant, and/or correspond, for example, to a (nominal) sensitivity (to the measured variable) specified or expected for the measuring system or to a (scale) zero point of the measuring system specified or expected for the measuring system. The reference (measurement) value for the at least one calibration parameter can, for example, be stored in the aforementioned (information) storage element of the sensor module, in particular in a non-volatile or permanent manner. Alternatively or in addition, the at least one reference (measurement) value can also be transferred externally, for example from the superordinate electronic data processing system and/or from the aforementioned (on-site) control unit (for the measuring system) via the aforementioned data line L2 and/or by radio, before or during putting into service (again) of the measuring system to the converter electronics, for example via data input, and stored there in a suitable manner, for example in a non-volatile manner; this can advantageously also be done together with the reference (measurement) data specifying the reference (calibration) conditions (established when determining the reference (measurement) value). The reference (measurement) value can also be part of a reference value ensemble (stored in the manner described above) that contains two or more reference (measurement) values for a plurality of sensor module-specific calibration parameters.

Furthermore, the converter electronics can also be arranged to control or execute the calibration of the base module of the measuring system (after the connection to the sensor module) in an automated manner and/or in dialogue with a user of the measuring system and/or in conjunction with the superordinate electronic data processing system. To display the (measuring system) data of the measuring system on-site and/or to operate or control the measuring system on-site during the putting (back) into service, the aforementioned display and control element HMI and/or the aforementioned external (on-site) control device coupled to the converter electronics with respect to signal communication can also be used for example.

For storing digital (measuring system) data, for example also of the at least one reference (measurement) value, the converter electronics may further comprise at least one non-volatile memory (EEPROM). In addition to the reference (measurement) value, in addition also (further) digital nominal or reference values for one or more (calibration) parameters characterizing the sensor module further, for example namely mechanically, electrically and/or electromechanically, and/or reference (measurement) values for one or more calibration parameters of other sensor modules that can later be used in the base module M1 and/or also one or more electronic certificates of the (corresponding) measuring system and/or (measuring system) data of the (corresponding) measuring system, for example one or more (digitized) measurement values and/or test results obtained with it, can advantageously be stored in a non-volatile manner in the memory (EEPROM), if necessary also together with corresponding location and/or (system) time and/or date information. Accordingly, according to a further development, it is provided, before or during the putting (back) into service of the measuring system, to read in (measuring system) data containing the at least one reference (measurement) value and/or identifying or verifying the sensor module, for example also stored in the aforementioned (information) storage element of the sensor module and/or in the aforementioned superordinate electronic data processing system EDP into the converter electronics, for example namely (immediately) before connecting the sensor module to the base module and/or during the connection of the sensor module to the base module and/or (immediately) after connecting the sensor module to the base module.

According to a further embodiment of the invention, the base module M2 has at least one first electric coil 12 electrically connected to the converter electronics, for example by means of corresponding (connecting) wires. The coil 12 can, for example, be cylindrical and/or configured as an air coil, possibly also at least partially coated with plastics material. In particular, the coil 12 can also serve (in interaction with the sensor module M2) to generate or adjust the—in this case inductive—(first) measuring signal. For example the sensor module M2 can also be configured to induce an electrical (alternating) voltage (of the base module) in the coil 12 (serving as signal voltage of the measuring signal) and/or a (first) (alternating) voltage induced (using the sensor module) in the first electric coil 12 can serve as a (signal) voltage of the (inductive) measurement signal. Accordingly, according to a further embodiment of the invention, the coil 12 is connected to the measuring signal input of the converter electronics. In addition, the converter electronics are configured to detect the aforementioned electrical (alternating) voltage induced in the coil 12 (by means of the sensor module) and to evaluate it as a (first) measurement signal or, using the aforementioned electrical (alternating) voltage induced in the coil 12 (by means of the sensor module), to determine measurement values for the at least one measured variable, for example, namely to determine (parameter) measurement values for at least one parameter of the (alternating) voltage, such as an amplitude, a frequency and/or a phase angle, and to calculate the measurement values for the at least one measured variable based on (parameter) measurement values determined for the (alternating) voltage. In the aforementioned case that the base module M1 has the (protective) housing 11, the electric coil 12 can be arranged within the chamber 11* and advantageously also be held by the housing 11, for example by the coil 12 being at least indirectly mechanically connected to the housing wall 11+.

According to a further embodiment of the invention, the sensor module M2 has at least one, for example cylindrical, first permanent magnet 22. Furthermore, the sensor module M2 can further comprise further permanent magnets, each positioned at a distance from the permanent magnet 22, in particular cylindrical and/or structurally identical to the permanent magnet 22, for example at least one second permanent magnet 24. In the aforementioned case that the base module M1 also has at least one electric coil 12 electrically connected to the converter electronics, the permanent magnet 22 is also connected to the sensor module M2 in such a way that the permanent magnet 22 (when the sensor module M2 is connected to the base module M1 or when the measuring system is finished) is held in a static (first) installation position predetermined with regard to an alignment and/or a smallest distance from the electric coil 12 and/or that an imaginary longitudinal axis of the permanent magnet 22 and an imaginary longitudinal axis of the electric coil 12 are aligned with one another or extend parallel to one another; this is done in particular in such a way that the permanent magnet 22 in said installation position together with the electric coil 12 forms a voice coil, in particular serving as an electrodynamic oscillation exciter, and/or—not least in the aforementioned case that the electric coil 12 is electrically connected to the measuring signal input of the converter electronics—a plunger coil, in particular serving as an electrodynamic oscillation sensor. For the aforementioned case that the base module M1 has the (protective) housing 11, the sensor module M2 is also configured according to a further embodiment of the invention to be installed in the base module 21 M1 in such a way that the aforementioned permanent magnet 22 is placed within the aforementioned chamber 11*, but is nevertheless spaced apart from the housing wall 11+, in particular is held in the aforementioned static (first) installation position E1 or (forming the aforementioned oscillating or plunger coil) is positioned and aligned relative to the coil 12 in the manner described above. Not least for the aforementioned case that the sensor module M2 has at least one second permanent magnet 24, the base module M1 in this embodiment of the invention can furthermore have at least one second electric coil 14 placed within the chamber 11* of the (protective) housing, for example cylindrical and/or configured as an air coil and/or structurally identical to the first electric coil 12, which second electric coil (removed from the electric coil 12) is at least indirectly mechanically connected to the housing wall 11+ and is also electrically connected to the converter electronics. In addition, the base module M2 can additionally be configured to receive the sensor module so that the permanent magnet 24 is held in a second installation position, in particular with respect to an alignment and/or remote from the first installation position, or that an imaginary longitudinal axis of the permanent magnet 24 and an imaginary longitudinal axis of the electric coil 14 are aligned with one another or are parallel to one another in extension. Furthermore, the sensor module M2 can also have more than two permanent magnets (22, 24) arranged at a distance from one another, thus at least one third permanent magnet 26, and the base module M1 can have more than two electric coils (14, 16) arranged at a distance from one another (within the chamber 11*) and/or each assigned to a permanent magnet, for example also identical in construction to the coil 12, thus at least one third air coil 16.

For the aforementioned case in which the sensor module has at least one (measuring) tube 31 or is formed by means of the at least one (measuring) tube 31, the at least one permanent magnet 22 can, as also schematically shown in FIG. 1, be fixed to the outside of the tube wall of the tube 31, for example, namely, on the outside of the aforementioned central segment, in particular, be connected thereto by material bonding; if additionally present, the aforementioned permanent magnet 24 and/or further permanent magnets (26) of the sensor module M2 can also be attached to the outside of the tube wall of the tube 31 or to its central segment. According to a further embodiment of the invention, the base module M1 and the sensor module M2 are also combined to form a vibration-type measuring sensor (of the measuring system), for example in such a way that an electro-mechanical oscillation exciter (12+22) is formed by means of the electric coil 12 (connected to the converter electronics ME) and the permanent magnet 22 (fixed to the outside of the tube) and/or a corresponding (electrodynamic) oscillation sensor of the measuring system is formed by means of one of the electric coils (12, 14, 16) (connected to the converter electronics ME) and the corresponding associated permanent magnet (22, 24 or 26) (fixed to the outside of the tube). In addition, in this embodiment of the invention, the at least one tube 31 or its central segment is particularly configured (driven by means of a oscillation exciter powered by the converter electronics) to perform forced bending or resonant oscillations around a static rest position and/or to be caused to vibrate in such a way that the at least one permanent magnet 22 is moved relative to the electric coil 12, in particular also each of the other permanent magnets 24, 26 is moved relative to the corresponding electric coil 14 or 16; this in particular while the aforementioned medium is guided in the lumen of the tube or flows through said lumen. Such mechanical oscillations of the at least one (measuring) tube 31 or its central segment can be excited or maintained, for example, by means of the aforementioned oscillation exciter formed by the permanent magnet 22 and the coil 12 and/or detected by means of the aforementioned oscillation sensor formed, for example, by the permanent magnet 22 and the coil 12 or by the permanent magnet 24 and the coil 14 or by the permanent magnet 26 and the coil 14, in particular in such a way that the corresponding oscillation sensor (22+12, 24+14, 26+16) provides the at least one (first) measurement signal, in particular both the first measurement signal and the aforementioned second measurement signal (each in the form of a oscillation signal representing said oscillations of the tube 31 or its central segment). In order to enable such vibrations of the at least one (measuring) tube 31 even when the sensor module is installed in the (protective) housing 11 of the base module M1, the sensor module M2, according to a further embodiment of the invention, is also installed in the (protective) housing 11 of the base module M1 in such a way that, as also shown schematically in FIG. 3a, the at least one (measuring) tube 31 is placed at least partially, for example also completely, within the chamber 11*, but at least its aforementioned central segment is spaced apart from the housing wall 11+.

In order to excite and maintain mechanical oscillations of the at least one (measuring) tube 31 or of the sensor module M2 formed therewith, the converter electronics ME is, according to a further embodiment, also configured to provide, at least temporarily, a first electrical (measuring system) driver signal and to introduce it into at least one of the electric coils (12, 14 or 16) of the base module M2, for example namely the first coil 12, in order to feed electrical power required for the aforementioned mechanical oscillations (of the sensor module) into the at least one electric coil; in particular in such a way that the at least one (measuring system) driver signal has an impressed alternating current and/or at least one signal frequency corresponding to a mechanical resonance frequency of the sensor module M2, in particular its at least one (measuring) tube 31. Alternatively or in addition, the converter electronics can, not least in the aforementioned case that the base module M1 also comprises at least the third electric coil 16 in addition to the first and second electric coils, also be configured to at least temporarily detect and evaluate a second electrical (alternating) voltage (of the base module), for example induced in the third coil 16, for example to calculate (parameter) measurement values for the at least one parameter of the second (alternating) voltage and/or a phase difference established between the aforementioned first and second (alternating) voltages based on the second (alternating) voltage; this in particular in order to calculate measurement values for the at least one measured variable to be detected by the medium based on the phase difference. According to a further embodiment of the invention, the converter electronics is also particularly configured to determine and evaluate (parameter) measurement values for the aforementioned phase difference, for example, namely to use one or more (parameter) measurement values for the phase difference to determine the (mass flow) measurement values and/or to compare them within the framework of a (self-) diagnosis of the measuring system with a previously determined (parameter) reference value and/or one or more threshold values predetermined for this purpose, and/or to determine measurement values for the at least one measured variable based on the phase difference established between the first and second (alternating) voltages (or one or more parameter measurement values determined for this purpose) and the at least one calibration parameter or a (converter) characteristic function formed therewith, in particular according to a (phase difference-to-mass flow measurement value) characteristic function (of the converter electronics) to determine the mass flow of the medium flowing through the sensor module. As is quite usual with such sensor modules or vibronic measuring systems formed therewith, the sensor module M2 can furthermore have at least one second (measuring) tube 32, for example also identical in construction and/or function to the first tube, with a tube wall forming an outer shell surface of the second tube, in particular made of a metal or a plastics material, and with a lumen wrapped by the same tube wall. In this case, the aforementioned second permanent magnet 24 or another permanent magnet of the sensor module can be fixed to the second tube, in particular be connected to it by material bonding, for example also opposite the permanent magnet 22 fixed to the first tube 31 and/or in such a way that an imaginary longitudinal axis of the permanent magnet 24 and an imaginary longitudinal axis of the permanent magnet 22 are aligned with one another or extend parallel to one another. Not least for the above-described case that the sensor module M2 is formed by means of two tubes (31, 32), the sensor module M2 can also have more than three permanent magnets arranged at a distance from one another, for example a total of at least six permanent magnets, and the base module M1 can accordingly have more than three electric coils arranged at a distance from one another within the chamber 11*, for example a total of at least six electric coils, for example each configured as air coils, for example in such a way that (with the sensor module installed in the base module) each of the two tubes is assigned exactly one oscillation exciter formed in the manner described above and exactly two oscillation sensors formed in the manner described above. The first and second (measuring) tubes 31, 32 can further be fluidically connected to one another by means of a first flow divider on the inlet side (fluidically connected to each of the two tubes) and a second flow divider on the outlet side (fluidically connected to each of the two tubes), as is quite common in vibronic measuring systems of the type in question, and may also be integrated into the course of the aforementioned (measuring substance) line during operation of the measuring system.

For simple, if necessary, recurring checking or verification of the functionality of the base module M1 as a whole or of the specified interaction of its (sub) components, in particular during a putting (back) into service of the measuring system on-site, the base module according to the invention is further calibrated using both the sensor module (already mechanically connected to the base module and coupled to the converter electronics with respect to signal communication) and the at least one reference (measurement) value specific to the sensor module, for example (meanwhile) stored in the converter electronics; this in particular using both the converter electronics and the still unused (brand-new) sensor module, namely one that has not yet been used for measuring the at least one measured variable after receipt from the manufacturer or after (first) connection and coupling to the base module, and/or using the sensor module connected to the base module or coupled thereto (immediately) before its first use for measuring the at least one measured variable, and/or in such a way that a reduction in the functionality of the base module, for example, impairing the measuring accuracy of the measuring system, can or will be detected. Accordingly, according to a further embodiment of the invention, the converter electronics are also configured to calibrate the base module both by means of the sensor module (mechanically connected to the base module and coupled to the converter electronics with respect to signal communication) and by means of the at least one reference (measurement) value for the sensor module-specific calibration parameter, for example in an automated or program-controlled manner, for example to determine one or more (actual) measurement values for the at least one calibration parameter based on the at least one measured signal (set by the sensor module) and to compare them with the at least one reference measurement value (for the at least one calibration parameter). Not least in the case described above that the measuring system is a mass flow measuring (modular) vibronic measuring system or Coriolis mass flow meter or that the (vibronic) sensor module and the base module are arranged to interact to generate the above-mentioned first and second measuring signals with a phase difference dependent on the mass flow, the at least one calibration parameter can correspond, for example, to a (scale) zero point of the measuring system representing a (zero) phase difference to be measured (nominally) at a mass flow of zero, or the reference measurement value (for the at least one calibration parameter) can quantify said (zero) phase difference accordingly.

A result of the calibration of the base module according to the invention can be, for example, a validation or qualification of the base module for further use to determine measurement values for the at least one measured variable or, for example, also a detection of damage or a defect in the base module, in particular due to mechanical wear and/or (mechanical) deformation of the base module and/or one or more faulty (electronic) components or (electronic) assemblies of the converter electronics.

According to a further embodiment of the invention, the calibration of the base module (by means of the sensor module) further comprises establishing (on-site) calibration conditions (of the measuring system). Said (on-site) calibration conditions may, for example, correspond to the aforementioned reference (calibration) conditions, i.e., those (measurement) conditions that were established when determining the reference (measurement) value for the sensor module-specific calibration parameter, for example during a (factory) calibration of the sensor module in a calibration laboratory or a calibration facility of the manufacturer. Alternatively or in addition, the (on-site) calibration conditions can be specified or prescribed accordingly in a, possibly also electronic, documentation of the sensor module. Establishing the (on-site) calibration conditions (of the measuring system) may accordingly comprise bringing the sensor module (connected to the base module) into contact with a (n) (on-site) calibration medium having, for example, a predetermined (medium) temperature and/or a predetermined (medium) pressure and/or a predetermined volume and/or mass flow. Said (on-site) calibration medium can accordingly, for example, have a constant (medium) temperature and/or one corresponding to a (reference) temperature (of a reference calibration medium) prevailing under reference (calibration) conditions, in particular one not less than 20° C., and/or a constant (medium) pressure and/or one that is static and corresponds to a (reference) pressure (of a reference calibration medium) corresponding to the reference (calibration) conditions, in particular not less than 0.8 bar, and/or a constant (medium) density and/or a (reference) density (of a reference calibration medium) corresponding to the reference (calibration) conditions, for example 0.09 kg/m³ or 1.29 kg/m³ or 1000 kg/m³, and/or at least temporarily a known and/or at least temporarily a constant, in particular a (constantly) zero, mass flow or be characterized accordingly. For example, a cleaning fluid also suitable for (on-site) sterilization (SIP-sterilization in place) and/or water or (water) vapor, in particular with a (medium) temperature of more than 100° C. and/or a (medium) pressure of not less than 1 bar, and/or air, in particular with a (medium) temperature of not less than 20° C. and/or a (medium) pressure of not less than 0.8 bar, and/or a (technical) purge gas, in particular air, carbon dioxide, nitrogen and/or argon, can be used, for example, as a calibration medium, in particular as a reference calibration medium and/or as an on-site calibration medium.

Advantageously, the calibration medium can also be supplied to the sensor module using the aforementioned line system used to carry the measurement medium. Accordingly, the integration of the sensor module into said line system takes place in accordance with a further embodiment (immediately) before the calibration of the base module or the calibration of the base module is only carried out after the sensor module is also integrated into the piping system.

In order to ensure that the calibration is started in a targeted manner, or to avoid that the calibration can be started in an uncontrolled manner, for example automatically by the converter electronics, the calibration of the base module according to a further embodiment of the invention comprises an execution of a (calibration) command by the converter electronics, in particular in such a way that the measuring system is put into calibration operation or that the use of the converter electronics to determine the one or more (actual) measurement values and comparison thereof with at least one reference (measurement) value is (only thereby) activated or made possible. The (calibration) command can, for example, signal the establishment of the (on-site) calibration conditions and/or be transmitted to the converter electronics by (manual) actuation of the aforementioned display and control element (of the measuring system). Alternatively or in addition, the (calibration) command can also be issued externally to the converter electronics, for example by means of the aforementioned superordinate electronic data processing system (EDP) and/or by means of the aforementioned external (on-site) control device, generated and/or sent to the converter electronics by means of data transmission, for example via radio and/or infrared and/or wired.

According to a further embodiment of the invention the calibration of the base module further comprises generating the at least one measurement signal (in a calibration operation of the measuring system or under (on-site) calibration conditions). Not least in the case described above that the sensor module is a vibronic sensor module or the measuring system formed with it is a vibronic measuring system, the generation of the at least one measurement signal (under calibration conditions) furthermore can also comprise a feeding of electrical power into the sensor module, for example into one or more of its aforementioned electric coils and/or by generating a (first) electrical (measuring system) driver signal, or the generation of at least one measurement signal (under calibration conditions) can further comprise generating an electrical (measuring system) driver signal (serving the feeding of electrical power into the sensor module) by means of the converter electronics, for example with an impressed alternating current and/or with a signal frequency corresponding to a mechanical resonance frequency of the sensor module.

According to a further embodiment of the invention the calibration of the base module also comprises using the converter electronics to determine one or more (actual) measurement values for the at least one calibration parameter based on the measurement signal (generated under calibration conditions) or the converter electronics is arranged accordingly to perform or control the calibration of the base module (in interaction with the sensor module connected to it). In addition, according to a further embodiment of the invention, the calibration of the base module comprises comparing one or more (actual) measurement values with the at least one reference (measurement) value (for the at least one calibration parameter). The comparison of the one or more (actual) measurement values with the at least one reference (measurement) value can advantageously take place directly within the converter electronics and/or can comprise determining a (statistical) key figure of the (actual) measurement values, for example a position measure of the (actual) measurement values and/or a scatter measure of the (actual) measurement values, and/or determining a deviation of the one or more (actual) measurement values or the aforementioned position measure of the (actual) measurement values from the at least one reference (measurement) value. Furthermore, the comparison of the one or more (actual) measurement values with the at least one reference (measurement) value can also comprise a comparison of the aforementioned deviation of the one or more (actual) measurement values from the at least one reference (measurement) value with a predetermined (deviation) threshold value, for example representing a defective base module and/or serving as a tolerance measure for a (still) intact base module or measuring system and/or as the limit of a tolerance range specified for a (still) intact base module or measuring system, and/or a comparison of the (statistical) key FIG. with a predetermined (key figure) threshold value, for example representing a defective base module and/or serving as a tolerance measure for a (still) intact base module or measuring system and/or as the limit of a tolerance range specified for a (still) intact base module or measuring system. Exceeding the corresponding at least one predetermined threshold value can also serve to initiate or trigger the generation of a (fault) message and/or the blocking of the base module. Alternatively or in addition, the comparison of the one or more (actual) measurement values with the at least one reference (measurement) value can also comprise storing a corresponding (comparison) result (“pass/fail”) in the converter electronics and/or in the aforementioned data processing system (EDP), for example also together with (measured) data specifying the (on-site) calibration conditions and/or together with location and/or (system) time and/or date information (further) specifying the calibration. Each of the aforementioned thresholds can, for example, also be used in the non-volatile memory (EEPROM) of the converter electronics. Accordingly, the calibration of the base module may also comprise detection of damage or a defect in the base module (“fail”-negative test or comparison result), in particular accompanied by a corresponding (on-site) message and/or at least a temporary blocking of the base module for further use to determine (qualified) measurement values for the at least one measured variable. The damage (to be detected or that is detected) or defect (to be detected or that is detected) may, for example, also be a reduction in the functionality of the base module, which impairs the accuracy of the measuring system.

According to a further embodiment of the invention, the calibration of the base module (in the event of a negative checking result) also comprises generating a (fault) message (“fail”) signaling a damaged or at least partially defective base module, in particular one that is also visually perceptible on-site, and/or also (at least temporarily) blocking the base module for (further) use in a measuring operation (of the measuring system); this particularly also applies in each case to the aforementioned case that one or more (actual) measurement values deviate from the at least one reference (measurement) value by more than a predetermined tolerance level and/or that a deviation of the one or more (actual) measurement values from the at least one reference (measurement) value and/or the aforementioned (statistical) key figure lies outside a (corresponding) tolerance range specified for an intact base module or measuring system. For the outputting of the (fault) message, for example also for its transmission to the superordinate data processing system (EDP) or for on-site display, for example, the aforementioned data output of the converter electronics or the aforementioned display and control element of the measuring system can also be used.

The aforementioned (at least provisional) blocking of the base module may also comprise removing the sensor module from the (at least provisionally blocked) base module and/or connecting the sensor module to another (unblocked) base module, for example, a (second) base module that is adjacent to and/or identical to the (at least provisionally blocked) base module (on site); this may be done, for example, in order to check the sensor module itself (immediately after blocking the base module) and/or to verify the plausibility of the aforementioned negative (comparison) result (“fail”) or to confirm it again (immediately after blocking the base module). Alternatively or in addition, the calibration of the base module can further comprise using a further (second) sensor module and/or a test module, for example according to the international application PCT/EP2022/076349 mentioned above, for repeatedly checking the base module; this also applies in particular to the aforementioned case in which a (n) (initially) negative checking result is present or in cases in which one or more (actual) measurement values deviate from the at least one reference (measurement) value by more than a predetermined tolerance level and/or in which a deviation of the one or more (actual) measurement values from the at least one reference (measurement) value and/or a (statistical) key figure of the (actual) measurement values lies outside a (corresponding) tolerance range specified for an intact base module or measuring system. Said repeated checking of the base module by means of the further (second) sensor module, in particular one identical to the sensor module, and/or the aforementioned test module can, for example, also be carried out (immediately) after the aforementioned (fault) message has been generated or the aforementioned blocking of the base module has been carried out. In addition, blocking the base module or creating the (fault) message, for example, also initiate a (n) (immediate) replacement of the defective base module with an intact (new) base module; this may also be accompanied by a new (on-site) calibration of the (new) base module, for example of the aforementioned test module and/or using another sensor module.

As an alternative to the aforementioned blocking of the base module or the aforementioned output of the fault message, the calibration of the base module May also comprise releasing the base module for (further) use in a measuring operation (of the measuring system) or for determining measurement values for the at least one measured variable (in the measuring operation); this applies not least in the event that a positive checking or comparison result (“pass”) is present or in cases where one or more (actual) measurement values do not deviate from the at least one reference (measurement) value or deviate by less than a predetermined tolerance level, for example also only in cases where none of the one or more (actual) measurement values deviates from the at least one reference (measurement) value by more than the tolerance level, and/or where the aforementioned deviation of the one or more (actual) measurement values from the at least one reference (measurement) value and/or the aforementioned (statistical) key figure of the (actual) measurement values lies within a (corresponding) tolerance range specified for an intact base module or measuring system. The release of the base module can in particular also comprise or enable the use of the measuring system formed by means of the base module and the sensor module and/or the at least one reference (measurement) value for the at least one calibration parameter (in the measuring operation of the measuring system) to determine measurement values for the at least one measured variable. For (further) checking of the sensor module on-site, it can occasionally be temporarily connected to another base module, for example the aforementioned (neighboring) second base module. Not least in the aforementioned case that the sensor module, for example due to the measurement medium and/or the type of process, is only approved for a one-time and/or time-limited use, the sensor module, after it has been removed from the base module (in exchange for a new sensor module), can advantageously be sent back to the manufacturer, for example to be measured again (for traceability of measurement values collected by means of the sensor module) and/or renewed (for reuse).

In order to ensure that the sensor module is actually a legitimate sensor module for the formation of the measuring system or for use in the base module, for example also for its calibration, it can also be advantageous to check the sensor module (on site), in particular to verify the sensor module or to confirm its legitimacy for use in the base module; this especially before connecting to the base module or before calibrating the base module and/or by comparing data identifying the sensor module with corresponding default data. According to a further embodiment of the invention, the checking of the sensor module accordingly comprises verification or authentication of the sensor module (on-site), for example using the converter electronics and/or the aforementioned (information) storage element of the sensor module, if necessary also comprising of the aforementioned superordinate electronic data processing system EDP connected to the converter electronics. The checking of the sensor module may, for example, also include checking whether the sensor module is suitable or (still) approved for forming the measuring system and/or calibrating the base module, for example also on the basis of one or more (electronic) certificates of the sensor module and/or a (n) (electronic) seal, possibly also attached to an outer packaging of the sensor module that serves as transport protection. Electronic data required for the checking of the sensor module can, for example, be stored (partially) in the converter electronics and/or in the aforementioned (information) storage element of the sensor module and/or in the aforementioned superordinate electronic data processing system EDP and can be retrieved from there as appropriate. The checking of the sensor module can, for example, be carried out in an automated manner and/or by (manual) actuation of the aforementioned display and control element HMI and/or by means of the aforementioned external (on-site) control device initiated or controlled. Said (on-site) control unit can also be arranged or used in particular for checking the aforementioned (electronic) seal of the sensor module. As a result, checking the sensor module can further comprise releasing the sensor module for forming the measuring system and calibrating the base module, if the sensor module is approved for this purpose, for example using the converter electronics or in such a way that the measuring system enables or activates a calibration operation useful for calibration by means of the converter electronics. Alternatively, checking the sensor module may also lead to the sensor module being blocked if the sensor module is not approved for use in the base module or is not appropriately verified; for example, this could happen during or (immediately) after checking the sensor module and/or in such a way that the sensor module is also blocked for a further calibration of the base module and/or for a calibration of another base module, for example by annulling the aforementioned certificate of the sensor module.

1-77. (canceled)

78. A method for on-site testing and/or putting into service of a modular vibronic measuring system configured to measure at least one physical and/or chemical measured variable of a measurement medium, being a liquid, a gas or a dispersion, which measuring system comprises:
a base module including converter electronics; and
a vibronic sensor module configured to be mechanically, securely and non-destructively detachably connected to the base module on-site, coupled to the converter electronics for signal communication, and calibrated in a manufacturer's factory,
wherein the sensor module is connected to the base module and configured to be contacted by a fluid medium, being the measurement medium and/or a calibration medium, and to adjust at least one signal parameter, being an electrical signal voltage, an electrical signal current, a signal frequency or a signal phase, of at least one electrical measurement signal applied to a signal input of the converter electronics as a function of the at least one measured variable of the fluid medium such that the at least one measurement signal follows a change in the at least one measured variable with a proportional change in the at least one signal parameter within a predetermined measurement range, and
wherein the converter electronics are configured to determine measurement values for the at least one measured variable using the at least one measured signal and at least one reference measurement value determined under reference calibration conditions for at least one sensor module-specific calibration parameter, being a reference frequency, a reference phase or a reference voltage, which for at least one calibration parameter characterizes the sensor module or the measuring system formed in an assembled state with the base module,
wherein the reference calibration conditions are at least one of:
the manufacturer's factory;
using a different, master base module identical in construction to the base module; and
using a reference calibration medium brought into contact with the sensor module,
the method comprising:
calibrating the base module using both the sensor module, mechanically connected to the base module and coupled to the converter electronics for signal communication, and the at least one reference measurement value for the at least one calibration parameter specific to the sensor module, which at least one reference measurement value is stored in the converter electronics.

79. The method according to claim 78, wherein calibrating the base module further comprises establishing on-site calibration conditions of the measuring system corresponding to the reference calibration conditions by bringing the sensor module connected to the base module into contact with the calibration medium having at least one of a predetermined medium temperature, a predetermined medium pressure, a predetermined volume, and mass flow.

80. The method according to claim 79, wherein establishing the on-site calibration conditions comprises bringing the sensor module connected to the base module into contact with an on-site calibration medium having at least one of the predetermined medium temperature, the predetermined medium pressure, the predetermined volume, and the mass flow.

81. The method according to the claim 80, wherein at least one of:
the on-site calibration medium has a constant and/or a reference temperature of the reference calibration medium corresponding to the medium temperature prevailing under reference calibration conditions and not less than 20° C.;
the on-site calibration medium has a constant and/or a static reference pressure of the reference calibration medium corresponding to the static medium pressure prevailing under reference calibration conditions and not less than 0.8 bar;
the on-site calibration medium has a constant and/or a reference density of the reference calibration medium corresponding to the reference calibration conditions, wherein the medium density is 0.09 kg/m³ or 1.29 kg/m³ or 1000 kg/m³;
the on-site calibration medium has at least temporarily a known mass flow and/or at least temporarily a constant mass flow and/or a constantly zero mass flow;
a cleaning fluid serves as the calibration medium, the calibration medium being the reference calibration medium and/or the on-site calibration medium;
water or steam having a temperature of more than 100° C. and/or a pressure of not less than 1 bar serves as the calibration medium, the calibration medium being the reference calibration medium and/or the on-site calibration medium;
air having a temperature of not less than 20° C. and/or a pressure of not less than 0.8 bar serves as the calibration medium, the calibration medium being the reference calibration medium and/or the on-site calibration medium; and
a purge gas serves as the calibration medium, the calibration medium being the reference calibration medium and/or the on-site calibration medium, wherein the purge gas is at least one of air, carbon dioxide, nitrogen, and argon.

82. The method according to claim 79, wherein calibrating the base module further comprises performing a calibration command, which signals the establishment of the on-site calibration conditions and/or is generated externally of the converter electronics and transmitted to the converter electronics via data transmission, by the converter electronics such that use of the converter electronics to determine the one or more measurement values and whose comparison with the at least one reference measurement value is activated or set in motion.

83. The method according to claim 82, wherein calibrating the base module further comprises transmitting the calibration command to the converter electronics by actuating a display and operating element of the measuring system, which is coupled to the converter electronics for signal communication, and/or from external to the converter electronics via data transmission.

84. The method according to claim 79, wherein calibrating the base module further comprises generating the at least one measurement signal in a calibration operation of the measuring system or under the calibration conditions.

85. The method according to claim 84, wherein generating the at least one measurement signal under the calibration conditions further comprises supplying electrical power into an electric coil of the base module by generating an electrical driver signal; and/or
wherein the generating of the at least one measurement signal under the calibration conditions further comprises generating the driver signal with an impressed alternating current and/or with a signal frequency corresponding to a mechanical resonance frequency of the sensor module so as to supply electrical power into the sensor module.

86. The method according to claim 84, wherein calibrating the base module further comprises using the converter electronics to determine one or more measurement values for the at least one calibration parameter based on the at least one measurement signal generated under the calibration conditions.

87. The method according to claim 86, wherein calibrating the base module further comprises comparing one or more measurement values with the at least one reference measurement value of the at least one calibration parameter.

88. The method according to claim 87, wherein comparing one or more actual measurement values with the at least one reference measurement value further comprises determining a deviation of the one or more measurement values from the at least one reference measurement value.

89. The method according to claim 88, wherein calibrating the base module further comprises comparing the deviation of the one or more measurement values from the at least one reference measurement value with a predetermined deviation threshold value, which represents a defective base module and/or serves as a tolerance measure for a still intact base module or measuring system and/or serves as a limit of a tolerance range specified for the still intact base module or measuring system and/or is dependent on the at least one reference measurement value.

90. The method according to claim 89, wherein exceeding the predetermined deviation threshold initiates or triggers generating a fault message or blocking of the base module.

91. The method according to claim 87, wherein comparing the one or more measurement values with the at least one reference measurement value further comprises determining a statistical key figure of the measurement values, which includes determining a position measure of the measurement values and comparing the position measure with the at least one reference measurement value.

92. The method according to claim 91, wherein calibrating the base module further comprises comparing the key figure, which key figure further includes a scatter measure of the measurement values, with a predetermined key figure threshold value, which represents a defective base module and/or serves as a tolerance measure for a still intact base module or measuring system and/or serves as a limit of a tolerance range specified for the still intact base module or measuring system and/or is dependent on the reference measurement value.

93. The method according to claim 92, wherein exceeding the predetermined key figure threshold value initiates or triggers generating a fault message or blocking of the base module.

94. The method according to claim 87, wherein comparing the one or more measurement values with the at least one reference measurement value further comprises storing a comparison result in a measuring electronics of the measuring system.

95. The method according to claim 94, wherein comparing the one or more measurement values with the at least one reference measurement value further comprises storing the comparison result in a data processing system (EDP) connected to the measuring electronics for signal communication, wherein the EDP is at least one of a programmable logic controller (PLC), a process control system (PCS), an edge computing device, and a cloud computing system, wherein measurement data specifying the on-site calibration conditions and/or location and/or system time and/or date information specifying the calibration are further stored with the comparison result.

96. The method according to claim 87, wherein calibrating the base module further comprises detecting damage or a defect in the base module.

97. The method according to claim 96, wherein calibrating the base module further comprises generating a fault message signaling a damaged or at least partially defective base module, which is visually perceptible on-site:
when one or more measurement values deviate from the at least one reference measurement value by more than a predetermined tolerance level; and/or
when a deviation of the one or more measurement values from the at least one reference measurement value and/or a statistical key figure of the measurement values lies outside a corresponding tolerance range specified for an intact base module or measuring system, wherein the key figure includes a position measure of the measurement values and/or a scatter measure of the measurement values.

98. The method according to claim 96, wherein calibrating the base module further comprises at least temporarily blocking the base module for further use in a measuring operation of the measuring system:
when one or more measurement values deviate from the at least one reference measurement value by more than a predetermined tolerance level, and/or
when a deviation of the one or more measurement values from the at least one reference measurement value and/or a statistical key figure of the measurement values lies outside a corresponding tolerance range specified for an intact base module or measuring system, wherein the key figure includes a position measure of the measurement values and/or a scatter measure of the measurement values.

99. The method according to claim 98, wherein blocking the base module comprises removing the sensor module from the blocked base module and/or connecting the sensor module to a non-blocked further base module on site.

100. The method according to claim 96, wherein the damage or defect of the base module is caused by mechanical wear and/or mechanical deformation of the base module and/or by faulty electronic components or electronic assemblies of the converter electronics.

101. The method according to claim 97, further comprising checking the sensor module using a further base module to verify a plausibility of comparison result or confirm the comparison result.

102. The method according to claim 87, wherein calibrating the base module further comprises using a further sensor module and/or a test module for repeated checking of the base module:
when one or more measurement values deviate from the at least one reference measurement value by more than a predetermined tolerance level; and/or
when a deviation of the one or more measurement values from the at least one reference measurement value and/or a statistical key figure of the measurement values lies outside a corresponding tolerance range specified for an intact base module or measuring system and/or after generating a fault message or blocking of the base module.

103. The method according to claim 87, wherein calibrating the base module further comprises releasing the base module for further use in a measuring operation of the measuring system or for determining measurement values for the at least one measured variable in the measuring operation:
when one or more measurement values do not deviate from the at least one reference measurement value or deviate by less than a predetermined tolerance value such that none of the one or more measurement values deviates from the at least one reference measurement value by more than the tolerance value; and/or
when a deviation of the one or more measurement values from the at least one reference measurement value and/or a statistical key figure of the measurement values lies within a corresponding tolerance range specified for an intact base module or measuring system, wherein the key figure includes a position measure of the measurement values and/or a scatter measure of the measurement values.

104. The method according to claim 103, wherein releasing the base module comprises or enables the use of the at least one reference measurement value for the at least one calibration parameter in the measuring operation of the measuring system to determine measurement values for the at least one measured variable.

105. The method according to claim 103, further comprising using the measuring system with the base module connected to the sensor module to measure the at least one measured variable.

106. The method according to claim 78, further comprising forming the measuring system by mechanically connecting the sensor module to the base module, which is already installed on-site, by inserting the sensor module into the base module and/or after a loosening and removal of another such sensor module from the base module.

107. The method according to claim 78, further comprising integrating the sensor module into a line system used to conveying the flowing fluid medium before calibrating the base module and/or before the connection to the base module.

108. The method according to claim 78, further comprising integrating the converter electronics or the measuring system formed thereby into a superordinate electronic data processing system (EDP), wherein the EDP is at least one of a programmable logic controller (PLC), a process control system (PCS), an edge computing device, and a cloud computing system.

109. The method according to claim 78, further comprising transmitting and storing the at least one reference measurement value for the at least one calibration parameter in the converter electronics with reference measurement data specifying the reference calibration conditions.

110. The method according to claim 78, further comprising installing the base module in a plant, including installing the base module in a cabinet of the plant or a frame of the plant and/or electrically connecting the converter electronics to a superordinate electronic data processing system (EDP) of the plant.

111. The method according to claim 110, further comprising installing the sensor module on-site into the base module installed in the plant, including removing another sensor module previously connected to the base module from the base module.

112. The method according to claim 78, wherein the at least one reference measurement value for the at least one calibration parameter is stored in an information storage element of the sensor module and/or a superordinate electronic data processing system (EDP) connected to the converter electronics, wherein the EDP is at least one of a programmable logic controller (PLC), a process control system (PCS), an edge computing device, and a cloud computing system, and/or in an on-site control unit for the measuring system.

113. The method according to claim 78, further comprising reading data containing the at least one reference measurement value and/or identifying or verifying the sensor module into the converter electronics before connecting the sensor module to the base module, during the connection of the sensor module to the base module, and/or immediately after connecting the sensor module to the base module, wherein the data is read from an information storage element of the sensor module and/or a superordinate electronic data processing system connected to the converter electronics.

114. The method according to claim 78, further comprising checking the sensor module before calibrating the base module.

115. The method according to claim 114, wherein at least one of:
the checking of the sensor module comprises verifying or authenticating the sensor module using the converter electronics, an information storage element of the sensor module, and/or a superordinate electronic data processing system connected to the converter electronics;
the checking of the sensor module comprises checking whether the sensor module is suitable for forming the measuring system and/or calibrating the base module, wherein the checking includes whether sensor module is still approved, via at least one of an electronic certificate, an electronic seal, using the converter electronics, an information storage element of the sensor module, and a superordinate electronic data processing system connected to the converter electronics; and
the checking of the sensor module comprises checking an electronic seal of the sensor module using the converter electronics and/or an on-site control unit for the measuring system.

116. The method according to claim 114, wherein the checking of the sensor module comprises releasing the sensor module for forming the measuring system and calibrating the base module, when the sensor module is approved for this purpose, using the converter electronics and/or based on an electronic certificate of the sensor module.

117. The method according to claim 78, further comprising:
blocking the sensor module for recalibration of the base module by annulling the sensor module certificate during or after the checking of the sensor module; and/or
blocking the sensor module for calibrating another base module by annulling the certificate during or after the checking of the sensor module.

118. The method according to claim 78, wherein the at least one measured variable is at least one of a mass flow, a volume flow, a density, and a viscosity.

119. A modular measuring system for performing the method according to claim 78, wherein the measuring system is a vibronic measuring system for measuring at least one physical and/or chemical measured variable of a measurement medium, being a liquid, a gas or a dispersion, which measuring system comprises:
a base module including converter electronics; and
a vibronic sensor module configured to be mechanically, securely and non-destructively detachably connected to the base module on-site, coupled to the converter electronics for signal communication, and calibrated in a manufacturer's factory,
wherein the sensor module is connected to the base module and configured to be contacted by a fluid medium, being the measurement medium and/or a calibration medium, and to adjust at least one signal parameter, being an electrical signal voltage, an electrical signal current, a signal frequency or a signal phase, of at least one electrical measurement signal applied to a signal input of the converter electronics as a function of the at least one measured variable of the fluid medium such that the at least one measurement signal follows a change in the at least one measured variable with a proportional change in the at least one signal parameter within a predetermined measurement range,
wherein the converter electronics are configured to determine measurement values for the at least one measured variable using the at least one measured signal and at least one reference measurement value determined under reference calibration conditions for at least one sensor module-specific calibration parameter, being a reference frequency, a reference phase or a reference voltage, which for at least one calibration parameter characterizes the sensor module or the measuring system in an assembled state with the base module,
wherein the reference calibration conditions are at least one of:
the manufacturer's factory;
using a different, master base module identical in construction to the base module; and
using a reference calibration medium brought into contact with the sensor module, and
wherein the converter electronics are configured to calibrate the base module using both the sensor module, mechanically connected to the base module and coupled to the converter electronics for signal communication, and the at least one reference measurement value for the at least one calibration parameter specific to the sensor module, in an automated or program-controlled manner, so as to determine one or more measurement values for the at least one calibration parameter based on the at least one measured signal, set by the sensor module, and to compare the measurement values with the at least one reference measurement value for the at least one calibration parameter.

120. The measuring system according to claim 119, wherein the converter electronics are configured to calibrate the base module by determining one or more measurement values for the at least one calibration parameter based on the at least one measurement signal, set by the sensor module, and comparing the measurement values with the at least one reference measurement value for the at least one calibration parameter.

121. The measuring system according to claim 120,
wherein the converter electronics are configured to generate a fault message signaling a damaged or at least partially defective base module and/or to block the base module from further use in a measuring operation of the measuring system when:
one or more measurement values deviate from the at least one reference measurement value by more than a predetermined tolerance value; and/or
a deviation of the one or more measurement values from the at least one reference measurement value and/or a statistical key figure of the measurement values lies outside a corresponding tolerance range specified for an intact base module or measuring system, wherein the key figure includes a position measure of the measurement values and/or a scatter measure of the (actual) measurement values, and
wherein the converter electronics are configured to release the base module for further use in a measuring operation of the measuring system or for determining measurement values for the at least one measured variable in the measuring operation when:
one or more measurement values deviate from the at least one reference measurement value by less than a predetermined tolerance such that none of the one or more measurement values deviates from the at least one reference measurement value by more than the tolerance; and/or
a deviation of the one or more measurement values from the at least one reference measurement value and/or a statistical key figure of the measurement values lies within a corresponding tolerance range specified for an intact base module or measuring system, wherein the key figure includes a position measure of the measurement values and/or a scatter measure of the measurement values.

122. The measuring system according to claim 119, wherein the sensor module or the measuring system formed thereby is detachably integrated into a line system serving to convey the at least temporarily flowing fluid medium such that the sensor module or the measuring system is integrated into a course of a measurement medium line of the line system.

123. The measuring system according to claim 119, wherein the converter electronics or the measuring system formed thereby is integrated into a superordinate electronic data processing system (EDP), wherein the EDP is at least one of a programmable logic controller (PLC), a process control system (PCS), an edge computing device, and a cloud computing system, wherein the converter electronics is connected to the superordinate electronic data processing system for signal and data communication.

124. The measuring system according to claim 123, wherein the converter electronics is configured to communicate via a data line and/or by radio with the superordinate electronic data processing system so as to perform, in co-operation, a calibration of the base module and/or a putting back into service of the measuring system in an automated manner and/or in dialogue with a user of the measuring system.

125. The measuring system according to claim 119, wherein the converter electronics includes at least one data output for outputting a fault message.

126. The measuring system according to claim 119, wherein the converter electronics includes a radio unit configured to transmit measuring system data and/or to receive the at least one reference measurement value.

127. The measuring system according to claim 119, wherein the converter electronics includes at least one data input configured to receive the at least one reference measurement value.

128. The measuring system according to claim 119, further comprising a display and/or an operating element.

129. The measuring system according to claim 119, wherein the converter electronics are configured to store, in a non-volatile manner, the at least one reference measurement value for the at least one calibration parameter, wherein the at least one reference measurement value is received externally with reference measurement data specifying reference calibration conditions.

130. The measuring system according claim 119, wherein the converter electronics is configured to receive the at least one reference measurement value for the at least one calibration parameter with reference measurement data specifying reference calibration conditions, wherein the reference measurement data is read out from an information storage element of the sensor module and/or received from a superordinate electronic data processing system connected to the converter electronics for signal and data communication and/or from a display and operating element connected to the measuring electronics for signal communication.

131. The measuring system according to claim 119, wherein the converter electronics are configured to store a comparison result of comparing the one or more measurement values with the at least one reference measurement value, including to store measuring system data specifying on-site calibration conditions, location, system time, and/or date information further specifying the comparison.

132. The measuring system according to claim 119, wherein the converter electronics is configured to receive a calibration command, the calibration command signaling establishment of on-site calibration conditions, and/or generated externally of the converter electronics and transmitted to the converter electronics via data transmission, from a superordinate electronic data processing system (EDP) connected to the converter electronics for signal and data communication and/or from a display and operating element, including an on-site control unit connected to the measuring electronics for signal communication.

133. The measuring system according to claim 119, wherein the converter electronics is configured to execute a calibration command, the calibration command signaling establishment of on-site calibration conditions and/or generated externally of the converter electronics and transmitted to the converter electronics via data transmission such that the use of the converter electronics to determine the one or more measurement values and the comparison thereof with the at least one reference measurement value is activated or made possible.

134. The measuring system according to claim 119, wherein the converter electronics are configured to supply electrical power into an electric coil of the base module via an electrical driver signal with an impressed alternating current.

135. The measuring system according to claim 134, wherein the converter electronics is configured to provide the electrical driver signal with a signal frequency corresponding to a mechanical resonance frequency of the sensor module.

136. The measuring system according to claim 119, wherein the sensor module and the base module are configured to be assembled on site without tools and/or to be disassembled without tools non-destructively.

137. The measuring system according to claim 78, wherein the base module is configured to receive the sensor module and to be connected thereto in a mechanically fixed, but nevertheless releasable manner, so as to form a vibration-type measuring transducer or a vibronic measuring system and/or such that the sensor module is immovably locked on and/or in the base module.

138. The measuring system according to claim 119, wherein the measuring system is a Coriolis mass flow/density meter and/or a Coriolis mass flow/viscosity meter.

139. The measuring system according to claim 119, wherein the base module includes at least one first electric coil disposed within a chamber of a housing of the base module and/or cylindrical and/or configured as an air coil and/or electrically connected to the measuring signal input of the converter electronics.

140. The measuring system according to claim 139, wherein at least one of:
an alternating voltage induced by the sensor module in the first electric coil serves as the signal voltage of the measurement signal;
the sensor module is configured to induce the alternating voltage serves as the signal voltage of the measurement signal in the first electric coil; and
the first electric coil is electrically connected to the signal input of the converter electronics via connecting wires.

141. The measuring system according to claim 139, wherein the at least one first electric coil includes at least one second electric coil disposed within a chamber of the housing of the base module and/or cylindrical and/or structurally identical to the first electric coil and/or positioned remotely from the first electric coil and/or electrically connected to the converter electronics.

142. The measuring system according claim 141, wherein the at least one second electric coil includes at least one third electric coil disposed within a chamber of the housing of the base module and/or cylindrical and/or structurally identical to the first and/or second electric coils and/or positioned remotely from the first and/or second electric coils and/or electrically connected to the converter electronics.

143. The measuring system according to claim 78, wherein the sensor module includes at least one first permanent magnet.

144. The measuring system according to claim 143, wherein the base module includes at least one first electric coil disposed within a chamber of a housing of the base module and/or cylindrical and/or configured as an air coil and/or electrically connected to the measuring signal input of the converter electronics,
wherein the sensor module is connected to the base module such that the at least one first permanent magnet is held in a static first installation position predetermined with respect to an alignment and/or a smallest distance from the at least one first electric coil and/or that an imaginary longitudinal axis of the at least one first permanent magnet and an imaginary longitudinal axis of at least one first electric coil are aligned with one another or extend parallel to each other.

145. The measuring system according to claim 144, wherein the first permanent magnet, in the first installation position, together with the at least one first electric coil forms an electrodynamic vibration exciter and/or a plunger coil serving an electrodynamic vibration sensor.

146. The measuring system according to claim 119, wherein the base module includes a housing including at least one chamber at least partially wrapped by a housing wall, and
wherein the sensor module is configured to be exchangeable such that the sensor module can be:
introduced into the chamber from outside the housing of the base module and/or through an opening of the housing provided in the housing wall; and
removed again from the base module, non-destructively and/or without tools, from outside the housing and/or through the opening of the housing.

147. The measuring system according to claim 146, wherein the base module includes at least one first electric coil disposed within a chamber of a housing of the base module and/or cylindrical and/or configured as an air coil and/or electrically connected to the measuring signal input of the converter electronics,
wherein the at least one first electric coil is at least indirectly mechanically connected to the housing wall and/or disposed within the chamber, but is nevertheless spaced apart from the housing wall, and held in a static first installation position predetermined with respect to an alignment and/or a smallest distance from the at least one first electric coil.

148. The measuring system according to claim 143, wherein the sensor module of the measuring system comprises at least one first tube, which is at least partially straight and/or at least partially curved, including a first tube wall forming an outer shell surface of the at least one first tube, which is made of a metal or a plastic material, and including a first lumen defined by the first tube wall, and
wherein the at least one first permanent magnet is fixed on the outside of the first tube wall on a central segment of the first tube wall, extending between a first segment end and a second segment end remote therefrom, and is connected to the first tube wall by material bonding.

149. The measuring system according to claim 148, wherein the sensor module is configured to be installed in the housing without tools such that the at least one first tube is disposed at least partially or completely within the chamber but is spaced apart from the housing wall.

150. The measuring system according to claim 148, wherein at least one of:
the at least one first tube is U-shaped or V-shaped at least in portions;
the at least one first tube is configured to be passed through by the fluid medium and to be oscillated during the passing through such that an alternating voltage induced using the sensor module in the at least one first electric coil represents oscillatory movements of the at least one first tube; and
the at least one first tube is configured for guiding the fluid medium flowing in the first lumen, with a predeterminable and/or flow direction directed from the first segment end on an inlet side to the second segment end on an outlet side, and to be oscillated while guiding the fluid medium, and
wherein at least one of:
the at least one first tube is configured to be oscillated and driven by a vibration exciter formed by the at least one first electric coil and the at least one first permanent magnet such that at least one central segment of the first tube wall extending between the first segment end and the second segment end remote therefrom executes vibrational movements about a static rest position and/or that the alternating voltage represents vibrational movements of the central segment;
the at least one first permanent magnet is fixed to the central segment of the first tube wall extending between the inlet-side first segment end and the outlet-side second segment end remote therefrom; and
the converter electronics are configured to determine measurement values for at least one measured variable of the measurement medium flowing through the first tube based on the alternating voltage.

151. The measuring system according to claim 148, wherein the at least one first tube of the sensor module includes an at least one second tube that is structurally identical and/or functionally identical to the at least one first tube, including a second tube wall forming an outer shell surface of the second tube, made of a metal or a plastic material, and including a second lumen wrapped by the second tube wall.

152. The measuring system according to claim 151, wherein the at least one first permanent magnet of the sensor module includes at least one second permanent magnet, which is cylindrical and/or identical in construction to the at least one first permanent magnet, and
wherein the base module is configured to receive the sensor module such that the at least one second permanent magnet is held in a second installation position, remote from the first installation position, such that an imaginary longitudinal axis of the at least one second permanent magnet and an imaginary longitudinal axis of a second electric coil of the base module are aligned with each other or are parallel to each other in extension.

153. The measuring system according to claim 152, wherein the at least one second permanent magnet, from the at least one first permanent magnet, is fixed on the outside of the central segment of the first tube wall of the at least one first tube thereto by material bonding.

154. The measuring system according to claim 153, wherein the at least one second permanent magnet, relative to the at least one first permanent magnet fixed to the first tube, is fixed to the second tube by material bonding such that an imaginary longitudinal axis of the at least one second permanent magnet and an imaginary longitudinal axis of the at least one first permanent magnet are aligned with each other or extend parallel to each other in extension.

155. Use of the measuring system according to claim 119 for measuring at least one physical and/or chemical measured variable of a fluid measurement medium, being a liquid, a gas or a dispersion, wherein the at least one measured variable is at least one of a mass flow, a volume flow, a density, and a viscosity.
